(19) United States
(12) Patent Application Publication
(10) Pub. No.: US 2025/0264991 A1
(43) Pub. Date: Aug. 21, 2025

(54) POSITIONING A GRAPHICAL KEYBOARD WITHIN A GRAPHICAL USER INTERFACE

(71) Applicant: Google LLC, Mountain View, CA (US)

(72) Inventors: Xu Liu, Mountain View, CA (US); Shumin Zhai, Los Altos, CA (US)

(21) Appl. No.: 18/858,522

(22) PCT Filed: May 24, 2022
(86) PCT No.: PCT/US2022/072538

§ 371 Date: Oct. 21, 2024

(51) Int. Cl. G06F 3/04886; G06F 3/01

(52) U.S. Cl. CPC G06F 3/04886; G06F 3/013; G06F 2203/04803

(57) ABSTRACT

A computing system is described that includes a memory that stores instructions, wherein the instructions, when executed by the one or more processors, cause the one or more processors to output, for display, a graphical user interface, and determine that a first portion of the graphical user interface includes content having at least a threshold probability that a user of the computing device 1) will view the content or 2) is viewing the content, wherein the graphical user interface further includes a second portion, and wherein the first portion and second portion are non-overlapping portions of the graphical user interface. The instructions may further cause the one or more processors to output, for display by the display device, an updated graphical user interface including a graphical keyboard such that a majority of the graphical keyboard visually overlays the second portion of the graphical user interface.

### BACKGROUND

Some computing devices (e.g., mobile phones, tablet computers) may output a graphical keyboard for display as part of a graphical user interface for receiving text input (e.g., using a presence-sensitive input device and/or display, such as a touchscreen). The graphical keyboard may enable a user of the computing device to enter text (e.g., an email, a text message, a document, etc.). For example, a display device of a computing device may output a graphical keyboard at a presence-sensitive input device that enables the user to enter data by indicating keys displayed at the display device by tapping on or swiping across one or more keys of the graphical keyboard.

### SUMMARY

Techniques of this disclosure may enable a computing device to display a graphical keyboard within an area of a graphical user interface so as to reduce the amount of viewed or likely to be viewed content obstructed by the graphical keyboard. For example, the computing device may determine that at least a portion of content included in the graphical user interface is being viewed or likely to be viewed by a user of the computing device and/or that at least a portion of the graphical user interface does not include content being viewed or likely to be viewed by the user. The computing device may determine to output the graphical keyboard within the portion of the graphical user interface that does not include content being viewed or likely to be viewed by the user. In various examples, if the portion of the graphical user interface that does not include content being viewed or likely to be viewed by the user is not sufficient for displaying the graphical keyboard, the computing device may resize the content (e.g., by switching an active application from operating in a full screen mode to operating in a split screen mode, by reducing the amount of a screen that is outputting the content, etc.) so as to create a portion of the graphical user interface that does not include content and output the graphical keyboard within the newly created portion of the graphical user interface.

In one example, this disclosure describes a method that includes outputting, by one or more processors of a computing device and for display by a display device, a graphical user interface, and determining, by the one or more processors, that a first portion of the graphical user interface includes content having at least a threshold probability of being viewed by a user of the computing device, wherein the graphical user interface further includes a second portion, and wherein the first portion and second portion are non-overlapping portions of the graphical user interface. The method may further include outputting, by the one or more processors and for display by the display device, an updated graphical user interface including a graphical keyboard such that a majority of the graphical keyboard visually overlays the second portion of the graphical user interface.

In another example, a computing system includes a display device, one or more processors, and a memory that stores instructions, wherein the instructions, when executed by the one or more processors, cause the one or more processors to output, for display by the display device, a graphical user interface, and determine that a first portion of the graphical user interface includes content having at least a threshold probability of being viewed by a user of the computing device, wherein the graphical user interface further includes a second portion, and wherein the first portion and second portion are non-overlapping portions of the graphical user interface. The instructions may further cause the one or more processors to output, for display by the display device, an updated graphical user interface including a graphical keyboard such that a majority of the graphical keyboard visually overlays the second portion of the graphical user interface.

In an additional example, a computer-readable storage medium is encoded with instructions that, when executed, cause one or more processors of a computing device to: output, for display by a display device of the computing device, a graphical user interface, and determine that a first portion of the graphical user interface includes content having at least a threshold probability of being viewed by a user of the computing device, wherein the graphical user interface further includes a second portion, wherein the first portion and second portion are non-overlapping portions of the graphical user interface. The instructions may further cause the one or more processors to output, for display by the display device, an updated graphical user interface including a graphical keyboard such that a majority of the graphical keyboard visually overlays the second portion of the graphical user interface.

In another example, a computing system includes means for outputting a graphical user interface for display, and means for determining that a first portion of the graphical user interface includes content having at least a threshold probability of being viewed by a user of the computing system, wherein the graphical user interface further includes a second portion, and wherein the first portion and second portion are non-overlapping portions of the graphical user interface. The computing device may further include means for outputting an updated graphical user interface for display including a graphical keyboard such that a majority of the graphical keyboard visually overlays the second portion of the graphical user interface.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device configured to display a graphical keyboard, in accordance with one or more techniques of the disclosure.

FIG. 2 is a block diagram illustrating an example computing device configured to determine user engagement with a graphical user interface of the device, in accordance with one or more techniques of the disclosure.

FIGS. 3A and 3B are conceptual diagrams illustrating example graphical user interfaces before and after executing a split-screen mode, in accordance with one or more techniques of the disclosure.

FIGS. 4A and 4B are conceptual diagrams illustrating example graphical user interfaces with blank space, in accordance with one or more techniques of the disclosure.

FIG. 5 is a conceptual diagram illustrating an example computing device configured to track eye gaze of a user, in accordance with one or more techniques of the disclosure.

FIGS. 6A and 6B are conceptual diagrams illustrating example graphical user interfaces that include user interfaces for a plurality of applications, in accordance with one or more techniques of the disclosure.

FIG. 7 is a flow diagram illustrating example operations for outputting a graphical keyboard within a graphical user interface, in accordance with one or more techniques of the disclosure.

### DETAILED DESCRIPTION

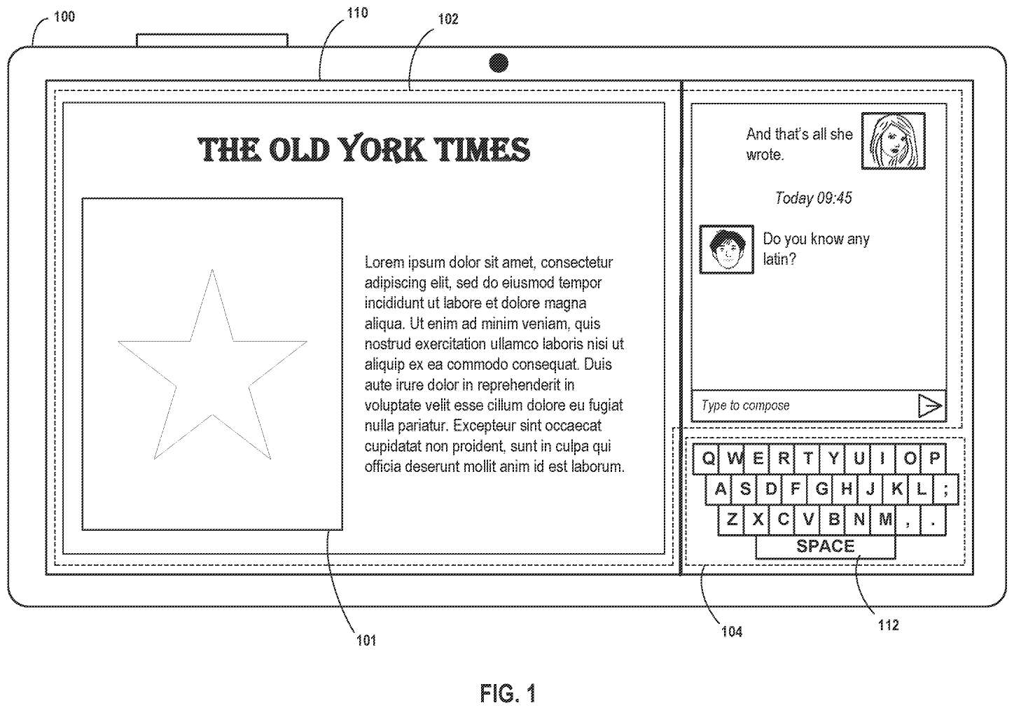

FIG. 1 is a conceptual diagram illustrating an example computing device configured to display a graphical keyboard, in accordance with one or more techniques of the disclosure. As shown in FIG. 1, computing device 100 is a mobile computing device (e.g., a tablet computer). However, in other examples, computing device 100 may be a mobile phone, a laptop computer, a desktop computer, a gaming system, a media player, an e-book reader, a television platform, an automobile navigation system, a wearable computing device (e.g., a computerized watch, computerized headset, computerized eyewear, a computerized glove), or any other type of mobile or non-mobile computing device.

Computing device 100 includes a user interface device (UID), which may function as an input device for computing device 100 and as an output device for computing device 100.

The UID may be implemented using various technologies. For instance, the UID may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology. The UID may function as an output (e.g., display) device using any one or more display devices, such as a liquid crystal display (LCD), dot matrix display, light emitting diode (LED) display, microLED, organic light-emitting diode (OLED) display, e-ink, or similar monochrome or color display capable of outputting visible information to a user of computing device 100.

The UID of computing device 100 may include a presence-sensitive display that may receive tactile input from a user of computing device 100. The UID may receive one or more indications of the tactile input by detecting one or more gestures from a user of computing device 100 (e.g., the user touching or pointing to one or more locations of the UID with a finger or a stylus pen). The UID may present output to a user, for instance at a presence-sensitive display. The UID may present the output as a graphical user interface (e.g., graphical user interface 110), which may be associated with functionality provided by computing device 100. For example, the UID may present various user interfaces of components of a computing platform, operating system, applications, or services executing at or accessible by computing device 100 (e.g., an electronic message application, an Internet browser application, a mobile operating system, etc.). A user may interact with a respective user interface to cause computing device 100 to perform operations relating to a function.

As shown in FIG. 1, graphical user interface (GUI) 110 includes content 101. In general, content 101 may include text, one or more pictures, video, graphics, or any other content of GUI 110 displayed by the display device. More specifically, in various examples, content 101 may include content such as words of a text document, an image of a website, a streaming movie, a graphics interchange format (GIF) image in an instant message application, a control element of a game, etc. Content 101 may be included in a graphical user interface of an application executing in the foreground (e.g., GUI 110). Content 101 may be of interest to the user of computing device 100. For example, the user may be viewing the content, interacting with the content, and/or about to view the content. In some examples, content 101 may not be of interest to a user, or of lesser interest to the user than other content of GUI 110.

An application or an operating system executing at computing device 100 may selectively cause the UID to display a graphical keyboard. For example, if a user is viewing a movie, the application and/or operating system of computing device 100 may determine that no textual input is required and, thus, not cause the UID to output the graphical keyboard. In another example, because a cursor may be included in a text entry field of the graphical user interface, the application and/or operating system may determine that textual input is required and cause UID to output the graphical keyboard. When outputting the graphical keyboard, a portion of content 101 or other portions of content included within GUI 110 may be obscured or visually moved such that the portions of content are no longer displayed or otherwise visible to a user of computing device 100. In instances where the content that is no longer visible is content the user wishes to view, the user may be required to provide additional inputs to scroll or otherwise adjust the content to make the desired content visible. The additional inputs cause computing device 100 to consume additional power by detecting the additional inputs, updating the content displayed by the UID, and by potentially having various components of computing device 100 (e.g., the UID) powered on for longer than may otherwise be required by a computing device that implements the techniques of this disclosure.

In accordance with one or more techniques of this disclosure, computing device 100 may identify, by the one or more processors, different portions of GUI 110 as including content of different relative importance to the user of computing device 100 and output graphical keyboard 112 for display within GUI 110 such that graphical keyboard 112 occludes as little of the content of interest as possible. For example, computing device 100 may determine that first portion 102 of GUI 110 includes content that is of interest to the user and, thus, relatively more important to the user such that the content included within first portion 102 should not be occluded. Similarly, computing device 100 may determine that second portion 104 of GUI 110 includes content that is not of interest or of less interest to the user and, thus, relatively less important to the user such that the content included in second portion 104 may be occluded, moved, or otherwise adjusted to accommodate including graphical keyboard 112 within GUI 110.

In determining what content of GUI 110 includes relatively more important or less important content, computing device 100 may determine a probability that the user of computing device 100 either will view or is viewing various portions of the content of GUI 110. If the determined probability does not satisfy a threshold probability, computing device 100 may determine that the associated portions of content are relatively less important. Conversely, if the determined probability does satisfy the threshold probability, computing device 100 may determine that the associated portions of content are relatively more important. Computing device 100 may determine the probability that the user is viewing or will view the content by tracking eye movements of the user, based on an active cursor focus (e.g., in an active text field), based on media content, by determining an amount of time each application from one or more currently executing applications has been visible on the display of the computing device, based on whether the user has viewed a portion of the content of GUI 110 within a threshold amount of time, based on whether promotional content is included within GUI 110, based on whether the portion of GUI 110 is blank (e.g., does not include textual or graphical elements other than a background image, a background color, etc.), or any combination thereof.

Computing device 100 may output graphical keyboard 112 such that content included in second portion 104 is occluded and a minimal amount of content included in first portion 102 is occluded. However, in some examples, second portion 104 may be too small (or nonexistent) to output graphical keyboard 112 at a size or location that provides sufficient usability for the user of computing device 100. In such examples, computing device 100 may resize first portion 102 and second portion 104 or may also split GUI 110 into a first partition and a second partition where the first partition includes content 101 and graphical keyboard 112 is included in the second partition.

By positioning graphical keyboard 112 within GUI 110 so as to reduce the amount of content of interest to the user that is occluded by graphical keyboard 112, techniques of this disclosure may improve the operational efficiency of computing device 100. For example, the techniques described here may reduce the number of user inputs required, may reduce the amount of time UID of computing device 100 is powered on, may reduce the amount of content rendering performed by computing device 100, or any combination thereof. Improving such operation efficiencies may reduce the amount of power consumed by computing device 100 during operation.

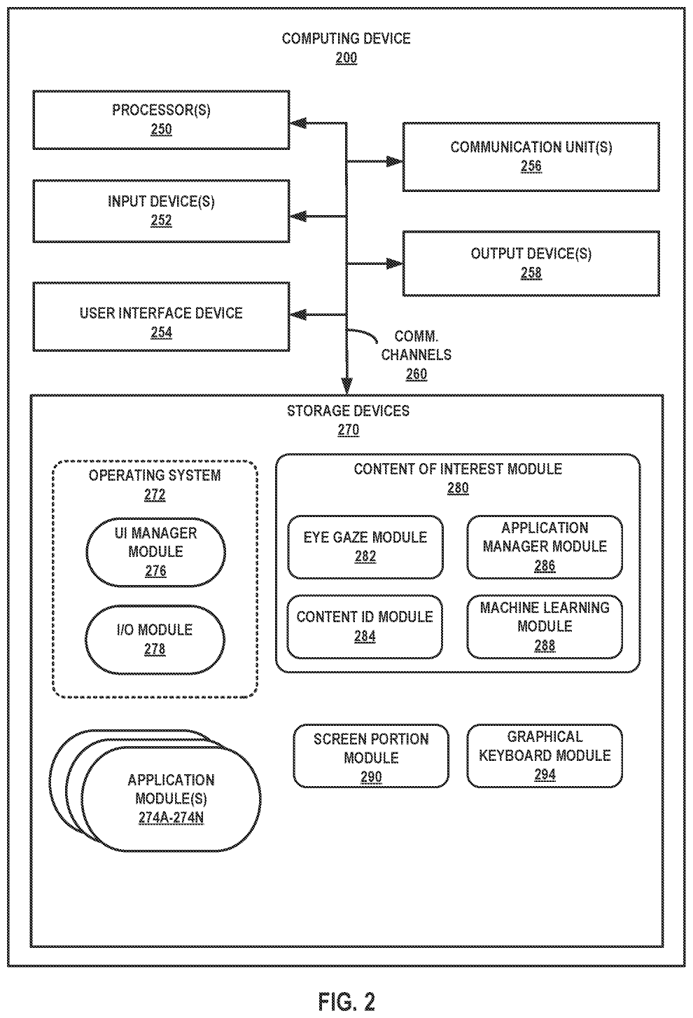

FIG. 2 is a block diagram illustrating an example computing device configured to determine user engagement with a graphical user interface of the device, in accordance with one or more techniques of the disclosure. Computing device 200 of FIG. 2 is an example of computing device 100 of FIG. 1. Computing device 200 is only one particular example of computing device 100 of FIG. 1, and may other examples of computing device 200 may be used in other instances and may include a subset of the components included in example computing device 200 or may include additional components not shown in FIG. 2.

As shown in the example of FIG. 2, computing device 200 includes one or more processors 250, one or more input devices 252, one or more communication units 256, one or more output devices 258, one or more storage devices 270, and user interface device 254. One or more storage devices 270 of computing device 200 may store operating system 272, UI manager module 276, I/O module 278, application modules 274A-274N, content of interest module 280, eye gaze module 282, content identification (ID) module 284, application manager module 286, machine learning (ML) module 288, screen portion module 290, priority module 292, and graphical keyboard module 294. Communication channels 260 may interconnect each of the components 250, 252, 254, 256, 258, and 270 for inter-component communications (physically, communicatively, and/or operatively). In some examples, communication channels 260 may include a system bus, a network connection, one or more inter-process communication data structures, or any other method for communicating data between hardware and/or software.

One or more input devices 252 of computing device 200 may receive input. Examples of input are tactile, audio, and video input. One or more input devices 252 of computing device 200, in one example, includes a mouse, keyboard, voice responsive system, video camera, microphone or any other type of device for detecting input from a human or machine. In some examples, input device 252 may be a presence-sensitive input device, which may include a presence-sensitive screen, touch-sensitive screen, etc.

One or more output devices 258 of computing device 200 may generate output. Examples of output are tactile, audio, and video output. Output devices 258 of computing device 200, in one example, includes a presence-sensitive screen, sound card, video graphics adapter card, speaker, liquid crystal display (LCD), miniLCD, microLCD, organic light emitting diode (OLED), or any other type of device for generating output to a human or machine.

One or more communication units 256 of computing device 200 may communicate with external devices via one or more networks by transmitting and/or receiving network signals on the one or more networks. For example, computing device 200 may use communication unit 44 to transmit and/or receive radio signals on a radio network such as a cellular radio network. Likewise, communication units 256 may transmit and/or receive satellite signals on a satellite network such as a GPS network. Examples of communication units 256 include a network interface card (e.g., an Ethernet card), an optical transceiver, a radio frequency transceiver, a GPS receiver, or any other type of device that can send and/or receive information. Other examples of communication units 256 may include Bluetooth®, GPS, 3G, 4G, and Wi-Fi® radios found in mobile devices as well as Universal Serial Bus (USB) controllers.

Computing device 200, in some examples, includes I/O (Input/Output) module 278. I/O module 278 may receive information from UI manager module 276 and output such information to devices with output functionality (e.g., user interface device 254, a communications unit, etc.). I/O module 278 may receive information from devices with input functionality (e.g., user interface device 254, a communications unit, etc.). For example, I/O module 278 may receive information that defines the GUI of computing device 200 from UI manager module 276 and one or more of application modules 274A-274N, content of interest module 280, eye gaze module 282, content ID module 284, application manager module 286, ML module 288, screen portion module 290, priority module 292, and graphical keyboard module 294, I/O module 278, based on the received information, may cause user interface device 254 to output the GUI for display. In some examples, I/O module 278 may determine an indication of user input performed at user interface device 254, and send such information to one or more of UI manager module 276, application modules 274A-274N, content of interest module 280, eye gaze module 282, content ID module 284, application manager module 286, ML module 288, screen portion module 290, priority module 292, and/or graphical keyboard module 294.

In some examples, user interface device 254 of computing device 200 may include functionality of input devices 252 and/or output devices 258. In some examples, the GUI may refer to a presence-sensitive display. In the example of FIG. 2, user interface device 254 may include a presence-sensitive input device, such as a presence-sensitive screen, touch-sensitive screen, etc. In some examples, a presence sensitive input device may detect an object at and/or near the presence-sensitive input device. As one example range, a presence-sensitive input device may detect an object, such as a finger or stylus that is within 2 inches or less of the presence-sensitive screen. The presence-sensitive input device may determine a location (e.g., an (x,y) coordinate) of the presence-sensitive input device at which the object was detected. In another example range, a presence-sensitive input device may detect an object 6 inches or less from the presence-sensitive input device and other ranges are also possible. The presence-sensitive input device may determine the location of the screen selected by a user's finger using capacitive, inductive, and/or optical recognition techniques. In some examples, user interface device 254 provides output to a user using tactile, audio, or video stimuli as described with respect to output device 258 For example, user interface device 254 may include a display device that presents a user interface, such as GUI 110 of FIG. 1. In some examples, a user may interact with the presence-sensitive input device, displaying GUI 110, to select characters from a graphical keyboard.

The presence-sensitive input device may include one or more touch sensors capable of detecting touch input from a user. Each touch sensor may include one or more electrical devices, such as capacitive sensors or resistive sensors, or may include one or more mechanical devices, such as switches or pressure plates. In one example, each touch sensor may include one or more simple capacitance sensors that detect a change in the capacitance of a material. Electrical hardware attached to each simple capacitance sensor may monitor the respective simple capacitance sensors for a change in capacitance. A change in capacitance may be determined by the attached electrical hardware and an indication may be output by the touch sensor. Other known sensor techniques providing the ability to sense touch input may also be employed to receive touch input from a user.

While illustrated as an integrated component of computing device 200, user interface device 254 may, in some examples, be an external component that shares a data path with other components of computing device 200 for transmitting and/or receiving input and output. For example, user-interface device 254 may be a built-in component of computing device 200 located within and physically connected to the external packaging of computing device 200 (e.g., a screen on a mobile phone). In another example, user-interface device 254 may be an external component of computing device 200 located outside and physically separated from the packaging of computing device 200 (e.g., a monitor, a projector, etc. that shares a wired and/or wireless data path with a tablet computer). In some examples, user interface device 254, when located outside of and physically separated from the packaging of computing device 200, may collectively refer to two components: a presence-sensitive input device for receiving input and a display device for providing output.

One or more storage devices 270 within computing device 200 may store information for processing during operation of computing device 200. In some examples, storage device 270 is a temporary memory, meaning that a primary purpose of storage device 270 is not long-term storage. Storage device 270 of computing device 200 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

Storage device 270, in some examples, also includes one or more computer-readable storage media. Storage device 270 may be configured to store larger amounts of information than volatile memory. Storage device 270 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage device 270 may store program instructions and/or data associated with operating system 272, UI manager module 276, I/O module 278, application modules 274A-274N, content of interest module 280, eye gaze module 282, content ID module 284, application manager module 286, ML module 288, screen portion module 290, priority module 292, and graphical keyboard module 294.

One or more processors 250 may implement functionality and/or execute instructions within computing device 200. For example, one or more processors 250 on computing device 200 may receive and execute instructions stored by storage device 270 that provide the functionality of operating system 272, UI manager module 276, I/O module 278, application modules 274A-274N, content of interest module 280, eye gaze module 282, content ID module 284, application manager module 286, ML module 288, screen portion module 290, priority module 292, and graphical keyboard module 294. These instructions executed by one or more processors 250 may cause computing device 200 to store and/or modify information, within storage device 270 during program execution. One or more processors 250 may execute instructions of operating system 272, UI manager module 276, I/O module 278, application modules 274A-274N, content of interest module 280, eye gaze module 282, content ID module 284, application manager module 286, ML module 288, screen portion module 290, priority module 292, and graphical keyboard module 294 to cause user interface device 254 to display the GUI. That is, operating system 272, UI manager module 276, I/O module 278, application modules 274A-274N, content of interest module 280, eye gaze module 282, content ID module 284, application manager module 286, ML module 288, screen portion module 290, priority module 292, and graphical keyboard module 294 may be operable by one or more processors 250 to perform various functions described herein, including determining portions of the GUI that include content having at least a threshold probability of being viewed by the user of the computing device, and causing user interface device 254 to present user the GUI at user interface device 254. It may be understood that description of computing device 200 or one or more components thereof (e.g., one or more modules in storage device 270) performing one or more operations of the disclosure may include one or more processors 250 implementing functionality and/or executing instructions thereof.

Content of interest module 280 may include instructions executable by one or more processors 250 to determine whether one or more portions of the GUI of computing device 200 include content of interest to the user. That is, content of interest module 280 may determine whether one or more portions of the GUI include content satisfying at least a threshold probability that the user of computing device 200 will view the content or is viewing the content. Content of interest module 280 may determine a first portion of the GUI including the one or more portions of the GUI that include content having at least the threshold probability that the user of computing device 200 will view the content or is viewing the content. Content of interest module 280 may also determine a second portion of the GUI including the one or more portions of the GUI that do not include content of interest to the user (e.g., does not satisfy the threshold probability that the user of computing device 200 will view or is viewing the content). After determining the first and second portions of the GUI, content of interest module 280 may send information defining the first and second portions of the GUI to screen portion module 290 to determine where in the GUI to display a graphical keyboard. Content of interest module 280 may determine whether the one or more portions of the GUI include content of interest based on output from one or more submodules including eye gaze module 282, application manager module 286, content ID module 284, and ML module 288.

In determining which portions of the GUI include content of interest to the user of computing device 200, content of interest module 280 may use information determined by one or more of eye gaze module 282, content ID module 284, or application manager module 286. For example, eye gaze module 282 may determine what portion(s) of the GUI at which the user of computing device 200 is looking, content ID module 284 may determine various types of content included in the GUI, and application management module 286 may determine various information about one or more applications (e.g., one or more application modules 274) executing at computing device 200.

Eye gaze module 282 may determine which portions of the GUI displayed by user interface device 254 at which the user is looking by, for example, tracking eye movements of the user. When tracking such eye movements, eye gaze module 282 may determine one or more gaze points of the user on the GUI displayed by user interface device 254. Eye gaze module 282 may determine a distance the user's head or eyes are from one or more cameras located on computing device 200 (e.g., one or more cameras of input devices 252) and may determine a location of the user's head or eyes in 3D space relative the one or more cameras.

In some examples, eye gaze module 282 may analyze one or more images captured by one or more cameras of computing device 200 to determine the distance between the one or more cameras and the user's eyes. As one example, eye gaze module 282 may analyze parallax angles between images captured by two or more different cameras given that the location of each of the two or more cameras is known. Using the parallax angles and the distance between the cameras, eye gaze module 282 determines the distance between one or more of the two or more cameras and the user's eyes. As another example, eye gaze module 282 may analyze an image captured by a single infrared camera to determine the distortion of the image captured by the infrared camera to determine the distance between the infrared camera and the user's eyes.

Using this determined distance between the one or more cameras and the user's eyes as well as the location of the user's eyes in the captured image(s), eye gaze module 282 may place the user's eyes in three-dimensional space relative to the one or more cameras. That is, eye gaze module 282 may determine a location of the user's eyes with reference to computing device 200 (i.e., relative to a location of at least one camera of computing device 200). The location of the user's eyes is a location within a 3D space defined relative to at least one camera. For example, the 3D space may be spherical and have a centroid that corresponds to a location of a camera. The location of the user's eyes, in such examples, may be defined in terms of (x,y,z) coordinates where (0,0,0) is the location of the camera that is being used as the centroid of the sphere. Such a coordinate may be referred to as being located within a “camera-based coordinate system.”

Using the position of the user's eyes and the movement of a pupil or other features of the eye, eye gaze module 282 may determine one or more eye gaze vectors. In some examples, eye gaze module 282 may use a pitch, roll, and/or yaw of a user's head about a particular axis to determine the one or more eye gaze vectors. Eye gaze module 282, using the one or more eye gaze vectors and the location of the user's eyes relative to the one or more cameras, determines one or more gaze points of the user on the GUI displayed on a display of computing device 200. Eye gaze module 282 may include instructions executable by one or more processors 250 for determining the number, timing, and/or location of gaze points on the GUI. Eye gaze module 282 may output the number, timing, and/or location of gaze points on the GUI to content of interest module 280 to determine whether the portions of the GUI including the gaze points include content of interest to the user.

In various instances, eye gaze module 282 may apply a trained machine learning model (e.g., ML module 288) to the camera image to determine one or more gaze points of the user on the GUI displayed by a display device of computing device 200. The machine learning model may be trained using images of users with known gaze points on an equivalent GUI displayed on an equivalent computing device. The machine learning model may continually learn based on user feedback and feedback provided by eye gaze module 282. For example, eye gaze module 282 may rank or adjust the parameters of the machine learning model based on updated training data received since the previous time the machine learning model was trained. After training, ML module 288 may be trained to receive image data as input and determine, as output, one or more gaze points of the user on the GUI.

Content ID module 284 may include instructions executable by one or more processors 250 for identifying content of the GUI running on computing device 200. For example, content ID module 284 may determine whether promotional content is included in the GUI, whether video or images are included in the GUI, whether an active text field is included in the GUI, and/or whether blank space is included in the GUI. After determining a type of content in the GUI, content ID module 284 may output data indicative of the content type, as well as the location of the content in the GUI, to content of interest module 280.

Content ID module 284 may also determine priority levels of the content of the GUI and output the priority levels to content of interest module 280. Content ID module 284 may determine priority levels based on the determined types of content of interest included in the GUI. In various instances, the priority levels may indicate a likelihood that the user is viewing or will view the content of interest. Content of interest with a higher priority level may be of heightened interest to the user, while content of interest with a lower priority level may likely be of least interest to the user and, thus, may be identified for possible occlusion by the graphical keyboard before content of interest with the higher priority level. Content ID module 284 may output the priority levels to content of interest module 280.

Responsive to receiving the data indicative of the content type from content ID module 284, content of interest module 280 may determine whether the content is of interest to the user, that is, whether the content satisfies the at least threshold probability that the user will view or is viewing the content. For example, content of interest module 280 may receive data indicative of promotional content from content ID module 284, may determine that the promotional content is not of interest to the user, and may determine that the portion of the GUI occupied by the promotional content is part of the second portion.

Application manager module 286 may contain instructions executable by one or more processors 250 for determining usage information of each application of one or more currently executing applications on computing device 200. For example, application manager module 286 may determine an amount of time each application from the one or more currently executing applications has been executing. Application manager module 286 may also determine a respective amount of time each of the one or more currently executing applications has been visible on the display device (e.g., user interface device 254) of computing device 200. Application manager module 286 may also include instructions for determining a foreground application. Application manager module 286 may output data indicative of the amount of time each application has been executing, the amount of time each application has been visible on the display device, and/or whether an application is the foreground application to content of interest module 280.

Content of interest module 280 may determine whether one or more of the application GUIs included in the GUI of computing device 200 includes content of interest. After receiving the data from application manager module 286, content of interest module 280 may determine, based on the data from application manager module 286, whether content of one or more application GUIs included in the GUI of computing device 200 satisfy the threshold probability that the user is viewing or will view the content. Content of interest module 280 may also determine that one or more portions of the GUI occupied by the one or more application GUIs is part of the first portion or second portion. For example, content of interest module 280 may determine that the foreground application includes content of interest. In some examples, content of interest module 280 may determine that the application GUI that has been visible on user interface device 254 for the longest amount of time includes content of interest.

ML module 288 may contain instructions for determining whether one or more portions of the GUI include content of interest to the user of computing device 200. ML module 288 may determine whether one or more portions of the GUI include content having at least a threshold probability that the user will view or is viewing the content. ML module 288 may include one or more machine learning algorithms configured to accept one or more representations of content of the GUI as input and output whether the content satisfies the threshold probability that the user is viewing or will view the content. Example machine learning techniques that may be employed include various learning styles, such as supervised learning, unsupervised learning, and semi-supervised learning. Example types of machine learning algorithms include Bayesian algorithms. Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, Convolution Neural Networks (CNN), Long Short Term Networks (LSTM), the Apriori algorithm, K-Means Clustering, k-Nearest Neighbour (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS). Principal Component Analysis (PCA) and Principal Component Regression (PCR).

In some examples, one or more machine learning models of ML module 288 may be configured to accept instructions for output of the GUI as input, and determine, as output from the one or more machine learning models, one or more portions of the GUI including content having the at least threshold probability that the user is viewing or will view the content. In some examples, one or more machine learning models of ML module 288 may be configured to accept instructions for output of the GUI as input, and determine, as output from the one or more machine learning models, one or more portions of the GUI including content that does not satisfy the at least threshold probability that the user is viewing or will view the content. In some examples, the one or more machine learning models may determine, as output, both the one or more portions of the GUI including content having the at least threshold probability, and the one or more portions of the GUI including content that does not satisfy the at least threshold probability. The one or more machine learning models of ML module 288 may be trained using training data stored in storage device 270. The training date may include a plurality of inputs to the one or more machine learning models corresponding to known outputs.

In some examples, the one or more machine learning models of ML module 288 may be trained to accept, as input, the output of one or more of eye gaze module 282, content ID module 284, and/or application manager module 286. The one or more machine learning models of ML module 288 may be trained to determine, as output, content of interest in the GUI of computing device 200 based on the input received from one or more modules 282, 284, and 286. For example, ML module 288 may accept, as input, a number and location of gaze points from eye gaze module 282, data indicative of content types from content ID module 284, and/or the amount of time each application of one or more currently executing applications has been visible on user interface device 254 from application manager module 286. Based on the number and location of gaze points, data indicative of content types, and/or the amount of time each application of one or more currently executing applications has been visible on user interface device 254, ML module 288 may output portions of the GUI that contain content of interest.

Using the information from one or more of modules 282, 284, 286, and 288, content of interest module 280 may determine one or more sizes of the one or more portions of the GUI including the content having at least the threshold probability that the user of computing device 200 will view the content or is viewing the content (e.g., the first portion) and the content not of interest to the user (e.g., the second portion), as well as whether the sizes satisfy one or more threshold sizes. In some examples, the second portion of the GUI may be too small to display a graphical keyboard without the graphical keyboard occluding at least some of the content of interest in the first portion. That is, content of interest module 280 may determine that a size of the second portion does not satisfy a threshold size, where the threshold size is correlated with a minimum-sized graphical keyboard.

In some instances where the threshold size is not satisfied, content of interest module 280 may determine whether the priority of the content of interest in the first portion that would be occluded by the graphical keyboard satisfies a lower priority threshold. In some examples, content of interest module 280 may determine that there is sufficient content included in the first portion that is of a low enough relative importance that the graphical keyboard may be output without partitioning the screen. Content of interest module 280 may, in addition or alternatively, adjust the threshold probability to include less content in the first portion and redetermine the sizes of the first portion and second portion based on the priority levels in view of the updated threshold probability.

Responsive to determining that the second portion is too small to display the graphical keyboard and/or that the content that would be occluded by the keyboard is not of low enough relative importance, content of interest module 280 may determine whether the GUI should enter a split screen mode. In order to determine whether the GUI should enter a split screen mode, content of interest module 280 may determine whether content of interest in the first portion can be shrunk without rendering the content of interest too difficult to see for the user. For example, content of interest 280 may compare an adjusted first portion size to a minimum first portion size associated with a type of content included in the first portion. Content types, such as image, video, advertisements, etc. may have a smaller minimum size than content of other types, such as text, links, input fields, etc.

Responsive to determining that content of interest in the first portion can be shrunk without rendering the content of interest too difficult to see, content of interest module 280 may instruct screen portion module 290 to execute the split screen mode. Responsive to determining that content of interest in the first portion cannot be shrunk without rendering the content of interest too difficult to see, content of interest module 280 may redetermine first portion and second portion based on priority levels output from content ID module 284 such that second portion is large enough to display the graphical keyboard.

Screen portion module 290 may include instructions executable by one or more processors 250 for executing a split-screen mode on computing device 200, and for determining where, within the GUI, to output a graphical keyboard for display. Screen portion module 290 may receive information from content of interest module 280 indicating a first portion of the GUI containing content deemed of interest to the user and a second portion of the GUI containing content deemed not of interest to the user, and instructions on whether or not to execute the split screen mode. For example, as described above, content of interest module 280 may determine that second portion is too small to display a graphical keyboard without the graphical keyboard occluding at least some of the content of interest in the first portion, and send instructions to screen portion module 290 to execute the split screen mode on computing device 200 to create more space to display the graphical keyboard. To execute the split screen mode, screen portion module 290 may split the GUI into at least a first partition and a second partition, where the first partition is smaller than the first portion of the GUI before the split, and the second partition is larger than the second portion of the GUI before the split. Screen portion module 290 may resize content for display in the first and second partitions. For example, screen portion module 290 may shrink content of the first portion so that the content fits into the first partition. Screen portion module may determine where within the second portion and/or second partition of the GUI to output a graphical keyboard for display.

Graphical keyboard module 294 may include instructions executable by one or more processors 250 to output, for display by the display device, a graphical keyboard in the GUI of computing device 200. Graphical keyboard module 294 may be a stand-alone application, service, or module executing at computing device 200 and, in other examples, graphical keyboard module 294 may be a sub-component thereof. For example, graphical keyboard module 294 may be integrated into a chat or messaging application executing at computing device 200 whereas, in other examples, graphical keyboard module 294 may be a stand-alone application or subroutine that is invoked by an application or operating platform of computing device 200 any time an application or operating platform requires graphical keyboard input functionality. In some examples, computing device 200 may download and install graphical keyboard module 294 from an application distribution platform (e.g., via the Internet) such as an application repository of a service provider. In other examples, graphical keyboard module 294 may be preloaded during production of computing device 200. In various examples, graphical keyboard module 294 may include instructions for determining a size of the user input device, and a corresponding minimum threshold size of the graphical keyboard for display.

Application modules 274A-274N may include instructions executable by one or more processors 250 for one or more applications to run on computing device 200. For example, application modules 274A-274N may include instructions for one or more of a messaging application, a browser application, a camera application, a music streaming application, or any other application for execution on computing device 200.

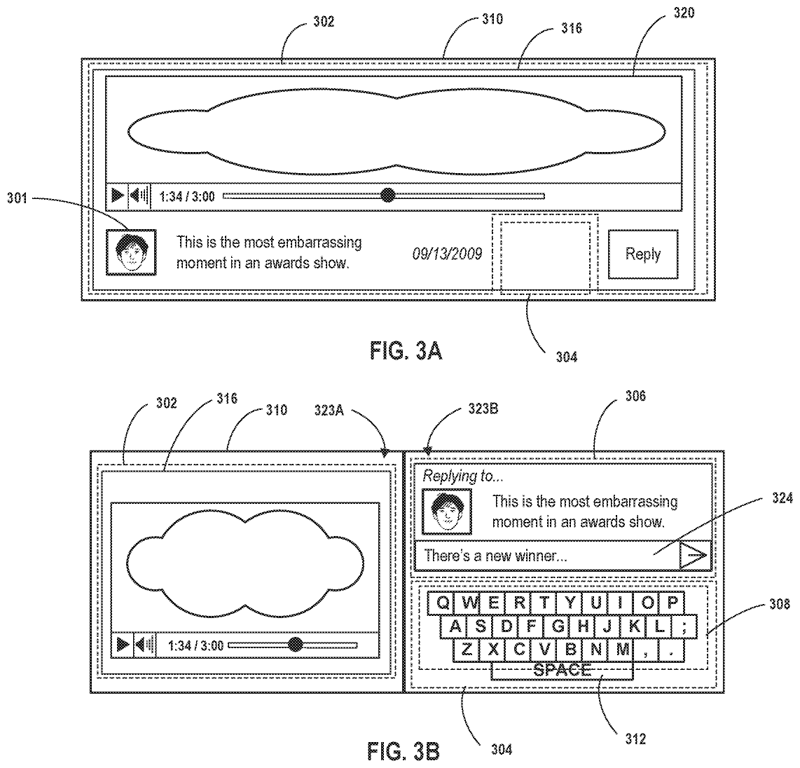

FIGS. 3A and 3B are conceptual diagrams illustrating example graphical user interfaces before and after executing a split-screen mode, in accordance with one or more techniques of the disclosure. FIGS. 3A and 3B are described with respect to computing device 200 of FIG. 2. In the example of FIG. 3A, GUI 310 includes content 301 of application GUI 316. Content 301 may include media 320, such as an image or a video.

In many computing devices (e.g., computing device 200), a graphical keyboard may not be displayed as part of GUI 310 until computing device 200 determines that the user may wish to enter text at computing device 200. For example, the user may reply to a comment on a website in a browser application, or the user may tap an incoming notification for a messaging application. However, once computing device 200 outputs the graphical keyboard for display, the graphical keyboard may obscure content of interest to a user of computing device 200 (e.g., content of interest in first portion 302 of GUI 310). Computing device 200 may determine whether one or more portions of GUI 310 include content of interest to the user, and output the graphical keyboard for display such that it does not occlude (or occludes as little as possible) content of interest to the user.

Content of interest module 280 of computing device 200 may determine whether one or more portions of GUI 310 include content of interest to the user, and from the one or more portions, determine a first portion 302 and a second portion 304 of GUI 310. Content of interest module 280 may determine that first portion 302 includes each of the one or more portions of GUI 310 that include content having at least a threshold probability of being viewed by the user of the computing device. That is, first portion 302 includes each of the one or more portions of GUI 310 that include content having at least a threshold probability that the user of computing device 200 1) will view the content or 2) is viewing the content. Content of interest module 280 may determine that second portion 304 includes each of the one or more portions of GUI 310 that do not include content satisfying the at least threshold probability. First portion 302 and second portion 304 may be non-overlapping portions of the GUI.

Content of interest module 280 may determine whether one or more portions of GUI 310 include content of interest to the user based on data output by content ID module 284. Content ID module 284 may determine a type of content 301, and output data indicative of the type of content 301 to content of interest module 280. For example, content ID module 284 may determine that a video or image is included in the graphical user interface. Content ID module 284 may examine labels of content 301 within application GUI 316 of GUI 310. One or more of the labels may indicate that content 301 within application GUI 316 includes images or video, and may also indicate the location in application GUI 316 where such content may be found. Using the location data, content ID module 284 may determine the position of the images or video in GUI 310 and the portion of GUI 310 containing the images or video. In some examples, content ID module 284 may determine that content 301 includes an active text field (e.g., active text field 324), where the active text field has a cursor focus. Content ID module 284 may output data indicative of the type of content 301 and the location of content 301 in the GUI to content of interest module 280.

Responsive to receiving the type and location of content 301 from content ID module 284, content of interest module 280 may determine the content is or is not content of interest. That is, content of interest module 284 may determine whether the content satisfies the threshold probability that the user will view or is viewing the content. For example, content of interest module 280 may determine that images or video satisfy the threshold probability that the user will view or is viewing the content. Users may focus on visual media when it is visible in GUI 310. Therefore, data in memory of computing device 200 may indicate that images or video satisfy the threshold probability. Content of interest 280 module may determine that the one or more portions of GUI 310 containing image and/or video are included in first portion 302. Content of interest module 280 may send data indicative of first portion 302 and second portion 304 to screen portion module 290 to determine where to output graphical keyboard 312 for display.

In the example of FIG. 3A, content ID module 284 may determine that content 301 includes an image, a video, text, and a graphical button in application GUI 316 of GUI 310. Content ID module 284 may output data indicative of content 301 and its locations in GUI 310 to content of interest module 280. Content of interest module 280 may determine that the image, video, text, and digital button are content of interest, and determine first portion 302 from the portions of GUI 310 including the image, video, text, and digital button. Content of interest module 280 may determine the remaining space in GUI 310 is second portion 304.

Content of interest module 280 may also determine that active text fields satisfy the threshold probability that the user will view or is viewing the content. Active text field 324 may display the typed text being submitted to active text field 324, which can allow users to actively confirm the correct selection of characters as the users type on a graphical keyboard (e.g., graphical keyboard 312). Therefore, data in memory of computing device 200 may indicate that active text fields satisfy the threshold probability. Content of interest module 280 may determine a third portion 306 of GUI 310 that includes active text field 324. In some examples, first portion 302 may include third portion 306. Content of interest module 280 may determine a fourth portion 308 of GUI 310 near or adjacent active text field 324, where second portion 302 includes fourth portion 308. In this way, content of interest module 280 may identify a portion of GUI 310 near or adjacent to the active text field that may be occluded by graphical keyboard 312 without occluding content of interest to the user.

In some examples, active text field 324 may not be output for display in GUI 310 until computing device 200 determines that the user may wish to enter text at computing device 200. In these instances, active text field 324 and graphical keyboard 312 may be output for display at roughly the same time. Content of interest module 280 may determine a size and location of third portion 306 that will contain active text field 324 from application data in one or more applications 274 containing instructions for the behavior of the active text field.

In the example of FIG. 3A, content of interest module 280 may determine that second portion 304 of GUI 310 is too small to fit a majority of graphical keyboard 312. For example, content of interest module 280 may determine a size of second portion 304 and whether the size of second portion 304 satisfies a threshold size. The threshold size may be any size preset in memory of computing device 200 (e.g., a rectangle of particular pixel dimensions). The threshold size may be a minimum threshold size for second portion 304 to satisfy the condition that a majority of a minimum-sized graphical keyboard 312 can visually overlay second portion 304.

While computing device 200 may output graphical keyboard 312 for display in any size or configuration on GUI 310, certain sizes and/or configurations may be disadvantageous to a user of computing device 200. For example, graphical keyboard 312 may be too small for fingers of the user to accurately select the one or more characters of graphical keyboard 312. Therefore, graphical keyboard 312 may occupy some minimum space on GUI 310.

Graphical keyboard module 294 may determine a size of the minimum-sized graphical keyboard and output data indicative of the size to content of interest module 280. In some examples, graphical keyboard module 294 may determine a size of a user input device used to select the one or more characters of graphical keyboard 312, and graphical keyboard module 294 may adjust the minimum size for graphical keyboard 312 based on the determined size of the user input device. One or more sensors of a capacitive touchscreen of computing device 200 may determine a surface area of interaction of the user input device with the capacitive touchscreen and determine the size of the user input device based on the surface area of interaction. In this way, graphical keyboard module 294 may set a larger minimum threshold size of graphical keyboard 312 for larger user input devices (e.g., fingers), and may set a smaller minimum threshold size of graphical keyboard 312 for smaller user input devices (e.g., styluses).

Responsive to determining that second portion 304 is too small to fit a majority of graphical keyboard 312 (e.g., the size of second portion 304 does not satisfy the threshold size), content of interest module 280 may determine whether screen portion module 290 should execute a split screen mode. In order to determine whether screen portion module 290 should execute a split screen mode, content of interest module 280 may determine whether content of interest in the first portion can be shrunk without rendering the content of interest too difficult to see in GUI 310 for the user. One or more minimum size thresholds for the content of interest may be stored in memory of computing device 200. Content of interest module 280 may determine whether the size of shrunken content of interest in a potential split screen mode satisfies the minimum size thresholds, and based on the determination, determine whether screen portion module 290 should execute the split screen mode. Content of interest module 280 may send data indicative of whether screen portion module 290 should execute the split screen mode to screen portion module 290.

Responsive to determining that content of interest in the first portion cannot be shrunk without rendering the content of interest too difficult to see, content of interest module 280 may redetermine first portion and second portion based on priority levels output from content ID module 284 such that second portion is large enough to display the graphical keyboard. For example, content ID module 284 may determine that GUI 310 includes both still images and playing videos. Content ID module 284 may determine that still images have a lower priority level than playing video, that is, still images should be occluded before a playing video. Content ID module 284 may therefore assign a higher priority level to playing video than to still images. Content of interest module 280 may receive one or more priority levels corresponding to one or more portions of identified content from content ID module 284. Content of interest module 280 may determine that content of interest with the lowest priority level should be part of second portion 304. For example, content of interest module 280 may receive a priority level for still images in GUI 310, a priority level for playing video in GUI 310, and a priority level for an active text field in GUI 310. The priority level for still images may be the lowest priority level. Content of interest module 280 may determine that the portion of GUI 310 including the still images is part of second portion 302. Content of interest module 280 may repeat this procedure until second portion 302 is large enough to display graphical keyboard 312. In this way, content of interest module 280 may prioritize display of content deemed more interesting to the user. Content of interest module 280 may send data indicative of the updated first portion 302 and second portion 304 to screen portion module 290.

Screen portion module 290 may receive data from one or more other modules to help screen portion module 290 to determine where to output graphical keyboard 312. Screen portion module 290 may receive data indicative of first portion 302 and second portion 304 from content of interest module 280. In some examples, the data indicative of first portion 302 and second portion 304 includes data indicative of third portion 306 and/or fourth portion 308. Screen portion module 290 may also receive data indicative of whether screen portion module 290 should execute the split screen mode from content of interest module 280. Screen portion module 290 may also receive data from graphical keyboard module 294 indicative of a size of graphical keyboard 312. Based on the data received, screen portion module 290 may determine where to output graphical keyboard 312.

In some examples, screen portion module 290 determines where to output graphical keyboard 312 based on receiving data indicating that screen portion module 290 should execute a split screen mode. For example, responsive to determining that content of interest in first portion 302 can be shrunk without rendering the content of interest too difficult to see, content of interest module 280 may instruct screen portion module 290 to execute the split screen mode (i.e., send data indicating that screen portion module 290 should execute the split screen mode). Screen portion module 290 may execute the split screen mode as shown in the example of FIG. 3B. To execute split-screen mode, screen portion module 290 may split GUI 310 into at least first partition 323A and second partition 323B, where second partition 232B is large enough to fit graphical keyboard 312. Screen portion module 290 may contain instructions for maintaining and controlling the number of partitions and the arrangement of the partitions within GUI 310. In some examples, each partition of the split screen mode may be a separate GUI output for display. Screen portion module 290 may resize at least some of content 301 of interest to fit within first partition 323A. In some examples, all of first portion 302 before the split is resized to fit into first partition 323A. In the example of FIG. 3B, screen portion module 290 has split GUI 310 into first partition 323A and second partition 323B, and reduced the size of some of the content of interest to fit into first partition 323A.

Screen portion module 290 may resize second portion 304 of GUI 310 within second partition 323B such that a majority of graphical keyboard 312 may visually overlay second portion 304 when output for display in GUI 310, and determine that graphical keyboard 312 should be output in second portion 304. In some examples, resized second portion 304 may occupy all of second partition 323B. In some examples, second partition 323B may include some content of interest. In the example of FIG. 3B, screen portion module 204 has increased the size of second portion 304 and included both second portion 304 as well as some content of interest in second partition 323B. In the example of FIG. 3B, the content of interest includes active text field 324.

Graphical keyboard module 294 may output, by one or more processors 250 and for display by the display device of computing device 200, an updated GUI 310 including graphical keyboard 312 such that a majority of graphical keyboard 312 visually overlays second portion 304 of GUI 310 in second partition 323B. In this way, graphical keyboard 312 may be output for display without occluding (or occluding as little as possible) content of interest to the user. To output graphical keyboard 312, UI manager module 276 may send information defining an updated GUI 310—including graphical keyboard 312 according to instructions from graphical keyboard module 294—to I/O module 278. Based on the information, I/O module 278 may cause user interface device 254 to output GUI 310 for display on the display device, including graphical keyboard 312.

In some examples, screen portion module 290 may determine where to output graphical keyboard 312 based on receiving data indicative of fourth portion 308 in second portion 304. For example, computing device 200 may provide a better user experience to users by outputting graphical keyboard 312 for display in an area of GUI 310 directly adjacent to an active text field (e.g., active text field 324). In doing so, computing device 200 may allow users to see both the one or more characters of graphical keyboard 312 as the user selects them, as well as the typed text being submitted to active text field 324. As described above, fourth portion 308 is a part of second portion 304 near or adjacent to active text field 324. Screen portion module 290 may determine that graphical keyboard 312 should be output for display in fourth portion 308 and send instructions to graphical keyboard module 294 for where to output graphical keyboard 312. U/O module 278 may cause user interface device 254 to output GUI 310 for display on the display device, including graphical keyboard 312 according to information received from graphical keyboard module 294, such that a majority of graphical keyboard 312 visually overlays fourth portion 308.

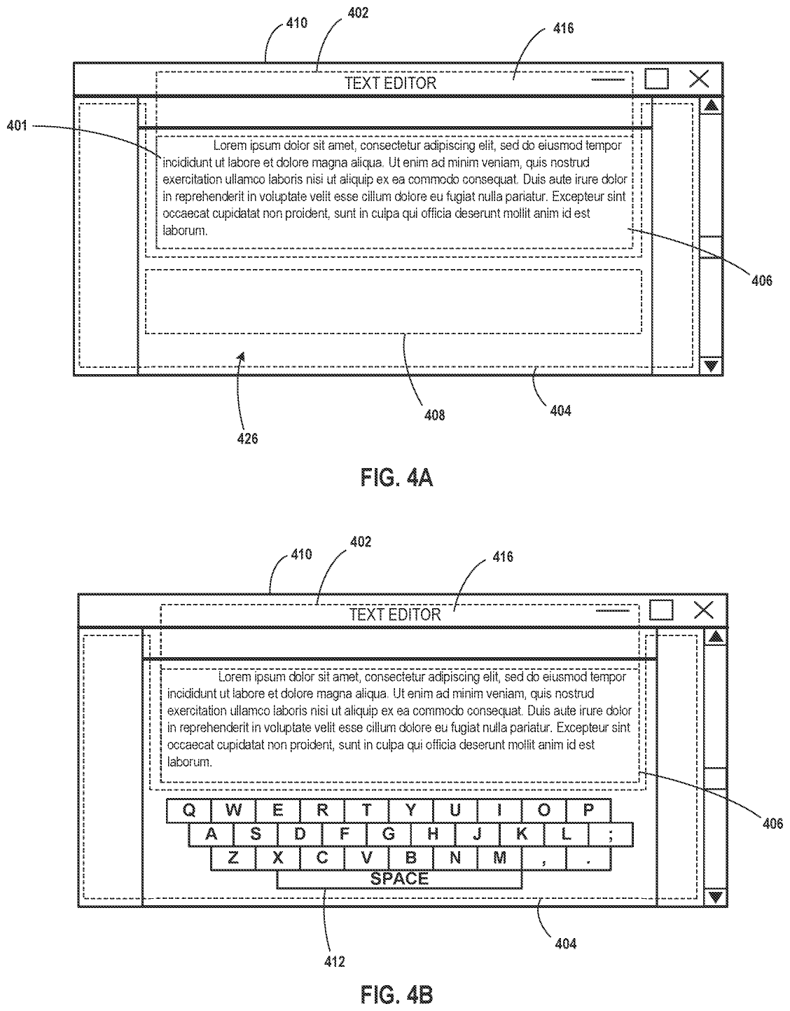

FIGS. 4A and 4B are conceptual diagrams illustrating example graphical user interfaces with blank space before and after output of a graphical keyboard for display, in accordance with one or more techniques of the disclosure. FIGS. 4A and 4B are described with respect to computing device 200 of FIG. 2. In the example of FIG. 4A, GUI 410 includes content 401 of application GUI 416, including blank space 426. GUI 410 includes first portion 402 and second portion 404.

Graphical keyboard 412 may not be displayed as part of GUI 410 until computing device 200 determines that the user wishes to enter text at computing device 200. For example, the user may open a text editing application. However, once computing device 200 outputs graphical keyboard 412 for display, graphical keyboard 412 may obscure content of interest to the user (e.g., content of interest in first portion 402 of GUI 410). Computing device 200 may determine whether one or more portions of GUI 410 include content of interest to the user, and output graphical keyboard 412 for display such that it does not occlude (or occludes as little as possible) content of interest to the user.

Content of interest module 280 of computing device 200 may determine whether one or more portions of GUI 410 include content of interest to the user, and from the one or more portions, determine a first portion 402 and a second portion 404 of GUI 410. Content of interest module 280 may determine that first portion 402 includes each of the one or more portions of GUI 410 that include content having at least a threshold probability of being viewed by the user of computing device 200. Content of interest module 280 may determine that second portion 404 includes each of the one or more portions of GUI 410 that do not include content satisfying the at least threshold probability. First portion 402 and second portion 404 may be non-overlapping portions of GUI 410.

Content of interest module 280 may determine whether one or more portions of GUI 410 include content of interest to the user based on data output by content ID module 284. Content ID module 284 may identify a type of content 401, and output data indicative of the type of content 401 to content of interest module 280. For example, content ID module 284 may determine that text or blank space 426 is included in the graphical user interface.

For example, application GUI 416 may be a text editing program. A portion of the text editing program displayed on the display of computing device 200 may include text in the body, as well as blank space 426 where there is no text. Instructions for execution of the text editing program may be included in one or more of application modules 274A-274N.

Content ID module 284 may examine labels of content 401 within application GUI 416 of GUI 410. One or more of the labels may indicate that content 401 within application GUI 416 includes text, and may also indicate the location in application GUI 416 where such content may be found. Using the location data, content ID module 284 may determine the position of the text in GUI 410 and the portion of GUI 410 containing the text.

In some examples, content ID module 284 may determine that content 401 includes an active text field, where the active text field has a cursor focus. In the example of FIGS. 4A and 4B, content ID module 284 may determine that the active text field includes the text of application GUI 416, as well as additional space around the text of application GUI 416 where typed text may appear.

In the example of FIG. 4A, content ID module 284 may also identify blank space 426 in application GUI 416. In some examples, content ID module 284 may determine that a portion of GUI 410 that contains fewer than a threshold number of features includes blank space 426. For example, content ID module 284 may determine that blank space 426 includes a portion of the display of GUI 410 with a monochromatic color scheme (e.g., the background of a webpage). In some examples, content ID module 284 may determine that blank space 426 includes a portion of GUI 410 where the color contrast ratio is below a threshold ratio. In some examples, content ID module 284 may determine that blank space 426 includes a portion of GUI 410 that includes fewer than a threshold number of straight lines (e.g., the edges of an open document in a text editing application). In some examples, content ID module 284 may determine that blank space 426 includes a portion of GUI 410 that includes simple repeating patterns (e.g., a series of cells in a spreadsheet application). Content ID module 284 may analyze information received from one or more application modules (e.g., application modules 274A-27N) in memory of computing device 200 containing instructions for output of application GUI 416 to determine where blank space 426 may be displayed in application GUI 416. Content ID module 284 may output data indicative of the type of content 401 and the location of content 401 in the GUI to content of interest module 280.

Responsive to receiving the type and location of content 401 from content ID module 284, content of interest module 280 may determine the content is or is not content of interest. That is, content of interest module 284 may determine whether the content satisfies the threshold probability that the user will view or is viewing the content. For example, content of interest module 280 may determine that text of the text editing program satisfies the threshold probability that the user will view or is viewing the content, and may determine that the portion of GUI 410 displaying the text is included in first portion 402 of GUI 410. The text of a text editing program is the main focus of the program. Therefore, data in memory of computing device 200 may indicate that text blocks in a text editing program satisfy the threshold probability. Content of interest module may determine that the one or more portions of GUI 410 containing text are included in first portion 402. Content of interest module 280 may determine that the portion of GUI 410 including blank space 426 is included in second portion 404 and does not satisfy the threshold probability that the user of computing device 200 will view or is viewing the content.

Content of interest module 280 may determine a third portion 406 of GUI 410 that includes the active text field. In some examples, first portion 402 may include third portion 406. Content of interest module 280 may determine a fourth portion 408 of GUI 310 near or adjacent active text field 324, where second portion 402 includes fourth portion 408. In this way, content of interest module 280 may identify a portion of GUI 410 near or adjacent to the active text field that may be occluded by graphical keyboard 412 without occluding content of interest to the user. Content of interest module 280 may send data indicative of first portion 402 and second portion 404 to screen portion module 290 to determine where to output graphical keyboard 412 for display.

Screen portion module 290 may receive data indicative of first portion 402 and second portion 404 from content of interest module 280 and, based on the data, determine where to output graphical keyboard 412 for display. Screen portion module 290 may determine that graphical keyboard 412 should be displayed in second portion 402. In this way, graphical keyboard 412 will not occlude (or occlude as little as possible) the content of interest in GUI 410.

In some examples, the data indicative of first portion 402 and second portion 404 includes data indicative of third portion 406 (the portion including the active text field) and/or fourth portion 408 (the segment of second portion 404 near or adjacent to the active text field). Computing device 200 may provide a better user experience to users by outputting graphical keyboard 412 for display in an area of GUI 410 near or adjacent to an active text field. In doing so, computing device 200 may allow users to see both the one or more characters of graphical keyboard 412 as the user selects them, as well as the typed text being submitted to the active text field. As described above, fourth portion 408 may be included in second portion 404 near or adjacent to the active text field. Screen portion module 290 may determine that graphical keyboard 412 should be output for display in fourth portion 408.

Screen portion module 290 may send instructions to graphical keyboard module 294 for where to output graphical keyboard 312. Graphical keyboard module 294 may output an updated GUI 410 including graphical keyboard 412 such that a majority of graphical keyboard 412 visually overlays second portion 404 of GUI 410 and/or fourth portion 408 of GUI 410 according to data received from screen portion module 290. In this way, graphical keyboard 412 may be output for display without occluding (or occluding as little as possible) content of interest to the user.

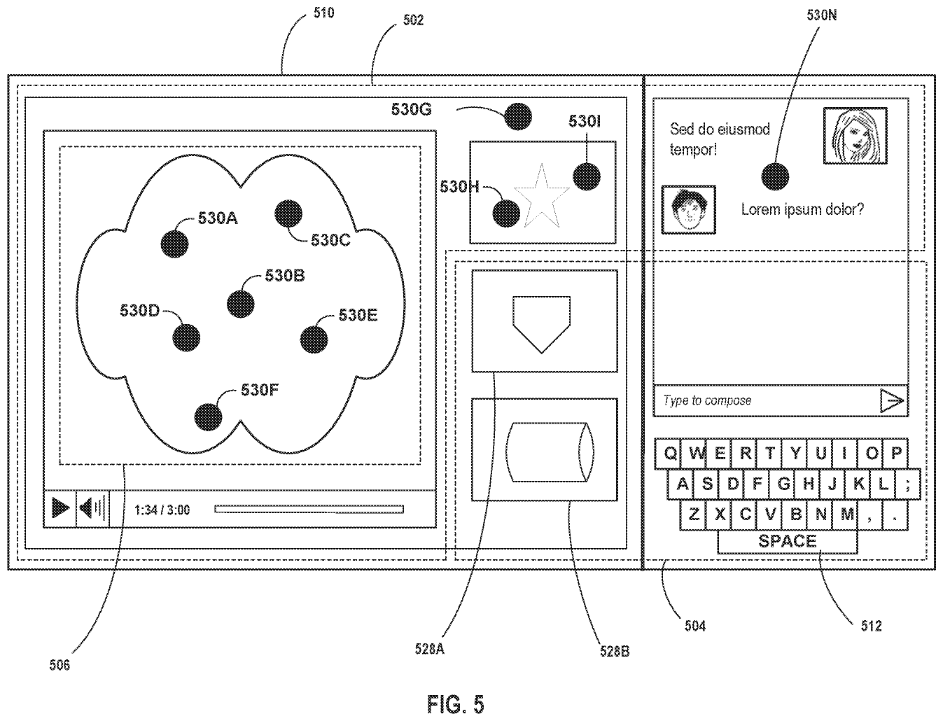

FIG. 5 is a conceptual diagram illustrating example computing device 200 configured to track eye gaze of a user, in accordance with one or more techniques of the disclosure. FIG. 5 is described with respect to computing device 200 of FIG. 2. In the example of FIG. 5, GUI 510 includes a plurality of gaze points 530A-530N (together, gaze points 530) and promotional content 528A-528B (together, promotional content 528).

Graphical keyboard 512 may not be displayed as part of GUI 510 until computing device 200 determines that the user wishes to enter text at computing device 200. However, once computing device 200 outputs graphical keyboard 512 for display, graphical keyboard 512 may obscure content of interest to the user (e.g., content of interest in first portion 502 of GUI 510). Computing device 200 may determine whether one or more portions of GUI 510 include content of interest to the user, and output graphical keyboard 512 for display such that it does not occlude (or occludes as little as possible) content of interest to the user.

Content of interest module 280 of computing device 200 may determine whether one or more portions of GUI 410 include content of interest to the user, and from the one or more portions, determine a first portion 502 and a second portion 504 of GUI 510. Content of interest module 280 may determine that first portion 502 includes each of the one or more portions of GUI 510 that include content having at least a threshold probability of being viewed by the user of computing device 200. Content of interest module 280 may determine that second portion 504 includes each of the one or more portions of GUI 510 that do not include content satisfying the at least threshold probability. First portion 502 and second portion 504 may be non-overlapping portions of GUI 510.

Content of interest module 280 may determine whether one or more portions of GUI 510 include content of interest to the user based on data output by content ID module 284. Content ID module 284 may identify a type of content 501, and output data indicative of the type of content 501 to content of interest module 280. For example, content ID module 284 may determine that promotional content 528 is included in the GUI 510. Promotional content may include advertisements, sponsored content, third-party content to the application, or any other type of promotional content. In the example of FIG. 5, GUI 510 includes promotional content 528A and 528B.

For example, an application GUI in GUI 510 may be a web browser. A portion of the web browser may include advertisements. Instructions for execution of the web browser may be included in one or more of application modules 274A-274N. Content ID module 284 may examine labels of the content within the web browser. One or more of the labels may indicate that content within the web browser includes promotional content 528, and may also indicate the location in the web browser where such content may be found. Using the location data, content ID module 284 may determine the position of promotional content 528 in GUI 510 and the portion of GUI 510 containing the promotional content.

Responsive to receiving the type and location of content 501 from content ID module 284, content of interest module 280 may determine the content is or is not content of interest. That is, content of interest module 284 may determine whether the content satisfies the threshold probability that the user will view or is viewing the content. For example, content of interest module 280 may determine that promotional content does not satisfy the threshold probability that the user will view or is viewing the content, and may determine that the portion of GUI 510 displaying the promotional content is included in second portion 504 of GUI 510.

Content of interest module 280 may determine whether one or more portions of GUI 510 include content of interest to the user based on data output by eye gaze module 282. Input devices 252 of computing device 200, may include one or more cameras. Eye gaze module 282 may determine which portions of GUI 510 at which the user is looking by, for example, tracking eye movements of the user using the one or more cameras. When tracking such eye movements, eye gaze module 282 may determine the one or more gaze points 530 of the user on GUI 510. Eye gaze module 282 may determine the one or more gaze points 530 as described above with reference to FIG. 2.

Content of interest module 280 may determine—based on data indicative of eye movements of the user received from eye gaze module 282—a probability that the user will view or is viewing at least a portion of the content of GUI 510. Based on the number and/or timing of gaze points 530 on GUI 510, content of interest module 280 may determine whether content of GUI 510 satisfies the threshold probability that the user is viewing or will view the content.

Eye gaze module 282 may determine, based on eye movements of the user, a number of times the user looks at content included in a third portion 506 of GUI 510. For example, eye gaze module 282 may determine a plurality of gaze points 530. For each portion of a plurality of portions of the content included in GUI 510, eye gaze module 282 may determine a number of gaze points 530 located in that respective portion. For example, eye gaze module 282 may determine a number of gaze points 530 located in third portion 506. Eye gaze module 282 may also determine a plurality of timestamps corresponding to each gaze point of gaze points 530, where each gaze point of gaze points 530 corresponds to a timestamp of the plurality of timestamps. Eye gaze module 282 may output the number of gaze points 530, their locations in GUI 510, and the plurality of timestamps corresponding to gaze points 530 to content of interest module 280.

Responsive to receiving the number, location, and timestamps associated with gaze points 530, content of interest module 280 may determine that content in those locations of GUI 510 is or is not content of interest. That is, content of interest module 284 may determine whether the content in those portions of GUI 510 satisfies the threshold probability that the user will view or is viewing the content.

For example, if the number of gaze points 530 located in third portion 506 of GUI 510 satisfies a threshold number, content of interest module 280 may determine that the probability that the user will view or is viewing content in third portion 506 satisfies the threshold probability. Content of interest module 280 may receive data from eye gaze module 282 indicating that eleven gaze points occurred in third portion 506. A threshold in memory of computing device 200 may indicate that any number of gaze points equaling or exceeding ten satisfies the threshold probability. In response to determining that the probability satisfies the threshold probability, content of interest module 280 may determine that third portion 506 is included first portion 502.

In some examples, content of interest module 280 may determine a proportion of gaze points 530 located in third portion 506. Content of interest module 280 may divide the number of gaze points 530 in third portion 506 from the total number of gaze points within a time period. For example, eye gaze module 282 may determine 100 gaze points within the last five minutes. Sixty gaze points may be located in third portion 506, or sixty percent of the determined gaze points. The time period may be a preset time period in memory, or a time period since eye gaze module 282 began determining gaze points. Content of interest module 280 may determine whether the proportion of gaze points 530 in third portion 506 satisfies a threshold proportion. For example, sixty percent of the determined gaze points may be located in third portion 506, and any percentage above fifty may satisfy the threshold proportion according to data in memory of computing device 200. In response to the proportion of gaze points 530 in third portion 506 satisfying the threshold proportion, content of interest module 280 may determine that content of third portion 506 satisfies the threshold possibility that the user will view or is viewing the content, and that third portion 506 is included in first portion 502.

Content of interest module 280 may determine, based on the timestamps of gaze points 530, whether content of GUI 510 satisfies the threshold probability that the user is viewing or will view the content. Content of interest module 280 may determine, for each gaze point of the plurality of gaze points 530, whether a difference between the corresponding time stamp for each gaze point and a current time (e.g., received from a system clock application of applications 274A-274N) satisfies a threshold amount of time. Responsive to determining that the time difference satisfies a threshold amount of time, content of interest module 280 may determine that the portion of GUI 510 including the gaze point with the corresponding timestamp satisfies the threshold probability that the user will view, or is viewing the content of that portion. For example, the difference between a corresponding time stamp for a gaze point and a current time could be five seconds. Data in memory may indicate that time differences less than twenty seconds satisfy the threshold probability. Content of interest module 280 may determine that the portion of GUI 510 including the gaze point with the corresponding timestamp that satisfies the threshold probability is included in first portion 302. In this way, content of interest module 280 may determine that more recently viewed portions of GUI 510 satisfy the threshold possibility that the user will view or is viewing those portions, and that those portions are included in first portion 302. Content of interest module 280 may determine that portions of GUI 510 that have not been viewed within a threshold amount of time do not satisfy the threshold possibility that the user will view or is viewing those portions, and that those portions are included in second portion 304. For example, data in memory may indicate that time differences greater than five minutes do not satisfy the threshold probability that the user is viewing or will view the content.

Content of interest module 280 may send data indicative of first portion 502 and second portion 504 to screen portion module 290 to determine where to output graphical keyboard 512 for display. Screen portion module 290 may receive data indicative of first portion 502 and second portion 504 from content of interest module 280 and, based on the data, determine where to output graphical keyboard 512 for display. Screen portion module 290 may determine that graphical keyboard 512 should be displayed in second portion 504. In this way, graphical keyboard 512 will not occlude (or occlude as little as possible) the content of interest in GUI 510. Screen portion module 290 may send instructions to graphical keyboard module 294 for where to output graphical keyboard 512. Graphical keyboard module 294 may output an updated GUI 510 including graphical keyboard 512 such that a majority of graphical keyboard 512 visually overlays second portion 504 of GUI 510 according to data received from screen portion module 290.

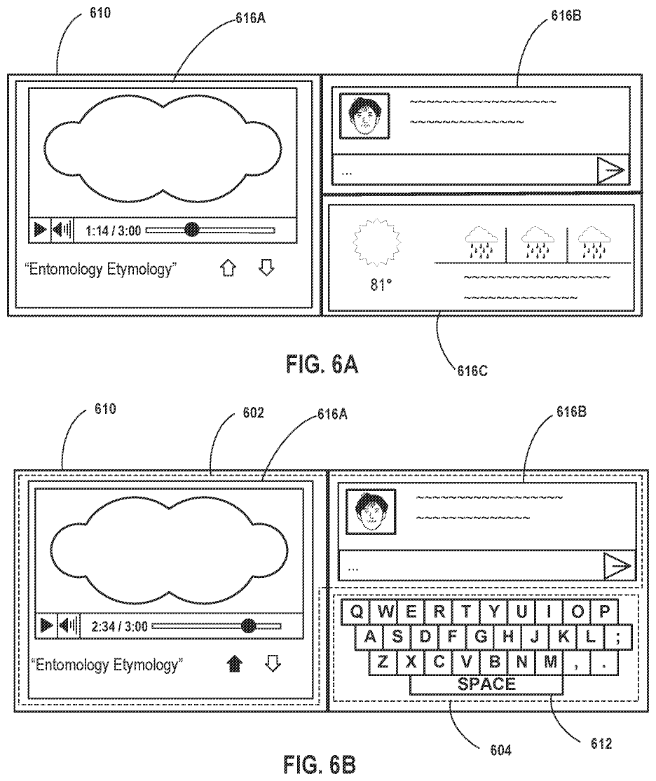

FIGS. 6A and 6B are conceptual diagrams illustrating example graphical user interfaces that include user interfaces for a plurality of applications, in accordance with one or more techniques of the disclosure. FIGS. 6A and 6B are described with respect to computing device 200 of FIG. 2. In the example of FIG. 6A, GUI 610 includes application GUIs 616A-616C. Although three application GUIs 616A-616C are depicted in FIGS. 6A and 6B, in other examples, GUI 610 may output any number of application GUIs. In some examples, the portion of GUI 610 displaying application GUI 616A may include a playing video, the portion of GUI 610 displaying application GUI 616B may include a messaging interface, and the portion of GUI 610 displaying application GUI 616C may include one or more animated graphics. Instructions for each of the application GUIs 616 may be included in one or more application modules 274A-274N.

Content of interest module 280 of computing device 200 may determine whether one or more portions of GUI 610 include content of interest to the user, and from the one or more portions, determine a first portion 602 and a second portion 604 of GUI 610. Content of interest module 280 may determine that first portion 602 includes each of the one or more portions of GUI 610 that include content having at least a threshold probability of being viewed by the user of computing device 200. Content of interest module 280 may determine that second portion 604 includes each of the one or more portions of GUI 610 that do not include content satisfying the at least threshold probability. First portion 602 and second portion 604 may be non-overlapping portions of GUI 610.

Content of interest module 280 may determine whether one or more portions of GUI 610 include content of interest to the user based on data output by application manager module 286. Application manager module 286 may determine usage information of each application of one or more currently executing applications on computing device 200 (e.g., the applications outputting application GUIs 616). Application manager module 286 may output data indicative of the usage information to content of interest module 280. For example, application manager module 286 may output data indicative of the amount of time each application has been executing, the amount of time each application GUI has been visible on the display device, and/or whether an application is the foreground application to content of interest module 280.

Application manager module 286 may determine an amount of time one or more currently executing applications outputting application GUIs 616 have been executing. Application manager module 286 may examine data from the one or more application modules 274A-274N corresponding to each of the one or more currently executing applications to obtain an application runtime. Application manager module 286 may examine data form the one or more application modules 274A-274N corresponding to each of the one or more currently executing applications to obtain a timestamp corresponding to the start time of each application and compare the start time with a current time (e.g., a current time obtained from a system clock). Application manager module 286 may output the amount of time the applications have been executing to content of interest module 280.

Application manager module 286 may determine an amount of time one or more currently executing application GUIs 616 have been visible on the display device displaying GUI 610. Application manager module 286 may determine that application GUI 616A has been visible on the display device for one hour and fourteen minutes, application GUI 616B has been visible on the display device for twenty minutes, and application GUI 616C has been visible on the display device for ten minutes. Application manager module 286 may output the amount of time each application GUI has been visible on the display device to content of interest module 280.

In some examples, application manager module 286 may determine one executing application that is a foreground application. That is, application manager module 286 may determine which task, process, application, window, etc. the user is currently using (e.g., is being actively interacted with by the user, has the cursor focus, etc.). Application manager module 286 may output data indicating the foreground application to content of interest module 280.

Responsive to receiving application usage data from application manager module 286, content of interest module 280 may determine whether content associated with each currently executing application is content of interest (e.g., satisfies the threshold probability that the user will view or is viewing the content). For example, content of interest module 280 may determine whether content associated with each currently executing application is content of interest based on whether an application is the foreground application. The application GUI with which a user is actively interacting is likely an application GUI with which the user would like to continue interacting. Data in memory of computing device 200 may indicate that the foreground application satisfies the threshold probability that the user will view or is viewing the content. Content of interest module 280 may determine that the portion of GUI 610 including an application GUI that is the foreground application satisfies the threshold probability and is included in first portion 602.

In some examples, content of interest module 280 may determine whether content associated with each currently executing application is content of interest based on the respective amount of time each application GUI 616 from the one or more currently executing applications has been visible on the display device.

Content of interest module 280 may determine, based on the respective amount of time the one or more application GUIs 616 have been visible on the display device, one application GUI from the one or more application GUIs 616 that has been visible on the display device for a greatest amount of time. Application manager module 286 may determine that content associated with the one application GUI satisfies the threshold probability that the user will view or is viewing the content. For example, application manager module 286 may determine that content of application GUI 616A visible on the display device for an hour and fourteen minutes satisfies the threshold probability. Application GUIs 616 that have been visible on the display device for an extended period may indicate that the user is actively engaging with the content of those applications. For example, application GUI 616A may include a playing movie or documentary that may contain content of interest to the user for the entirety of a length of the movie/documentary. Content of interest module may determine that the portion of GUI 610 including application GUI 616A is included in first portion 602.

Content of interest module may determine, based on the respective amounts of time the one or more application GUIs 616 have been visible on the display device, one application GUI from the one or more application GUIs 616 that has been visible on the display device for a least amount of time. Application manager module 286 may determine that content associated with the one application GUI does not satisfy the threshold probability that the user will view or is viewing the content. For example, application manager module 286 may determine that application GUI 616C visible on the display device for ten minutes does not satisfy the threshold probability. An application that has not been visible for very long may not contain content that is of interest to a user for longer than a brief moment. For example, application GUI 616C may include a weather application which is of interest to a user for only as long as it takes for the user to determine if it is going to rain that day. Content of interest module 280 may determine that the portion of GUI 610 including application GUI 616C is included in second portion 604.

In some examples, application manager module 286 may determine that the one application GUI that has been visible on the display device for the least amount of time includes content that satisfies the threshold probability that the user will view or is viewing the content. Application manager module 286 may determine that application GUI 616B visible on the display device for sixty seconds satisfies the threshold probability. An application GUI 616B that the user has only recently opened may contain content that is of interest to a user, e.g., the user may not have had time to perform any intended interactions with application GUI 616B. For example, application GUI 616B may include a recently opened messaging application with unread messages. An application that the user has only recently opened may also be the foreground application. Content of interest module 280 may determine that the portion of GUI 610 including application GUI 616B is included in first portion 602.

Content of interest module 280 may send data indicative of first portion 602 and second portion 604 to screen portion module 290 to determine where to output graphical keyboard 612 for display. Screen portion module 290 may receive data indicative of first portion 602 and second portion 604 from content of interest module 280 and, based on the data, determine where to output graphical keyboard 612 for display. Screen portion module 290 may determine that graphical keyboard 612 should be displayed in second portion 604. In this way, graphical keyboard 612 will not occlude (or occlude as little as possible) the content of interest in GUI 610. Screen portion module 290 may send instructions to graphical keyboard module 294 for where to output graphical keyboard 612. Graphical keyboard module 294 may output an updated GUI 610 including graphical keyboard 612 such that a majority of graphical keyboard 612 visually overlays second portion 604 of GUI 610 according to data received from screen portion module 290.

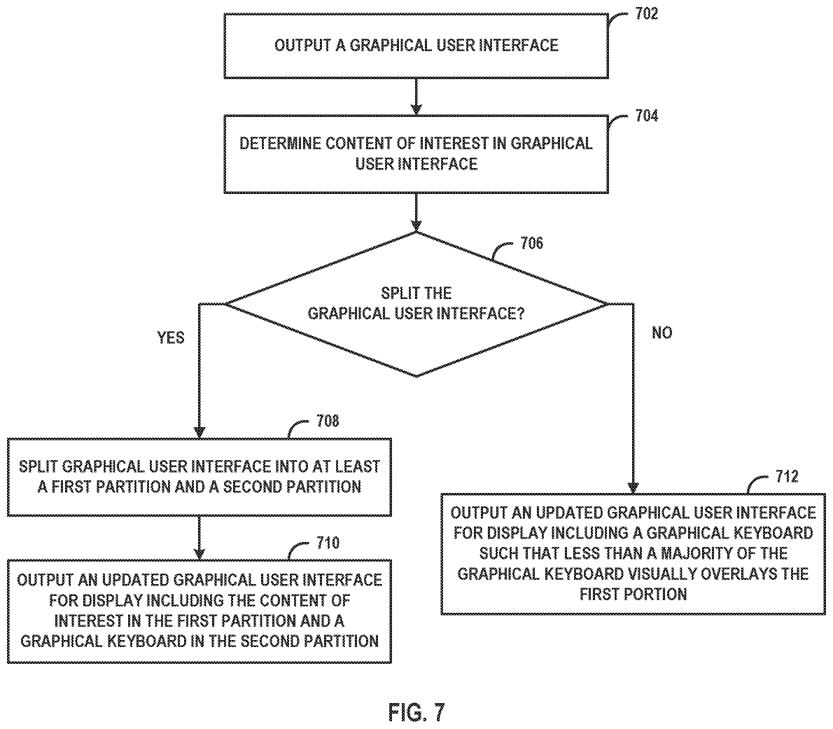

FIG. 7 is a flow diagram illustrating example operations for outputting a graphical keyboard within a graphical user interface, in accordance with one or more techniques of the disclosure. For ease of description, the operations may be described with reference to components of FIG. 2.

One or more processors 250 of computing device 200 may output, for display by user interface device 254, a GUI, such as GUI 110 of FIG. 1, GUI 310 of FIG. 3A, GUI 410 of FIG. 4A, GUI 510 of FIG. 5, or GUI 610 of FIG. 6A, as non-limiting examples (702). The GUI may include a plurality of content, such as text, pictures, video, graphics, etc. For example, content may include the words of a text document, the images of a news website, a streaming movie, a graphics interchange format file in an instant message application, and/or buttons of a digital game. The content may be part of one or more currently executing applications of the GUI.

Content interest module 280 may determine content of interest in the GUI (704). Some content of the GUI may be of interest to the user of computing device 200. For example, the user may be viewing the content, interacting with the content, and/or about to view the content. Some content may not be of interest to a user, or of lesser interest than other content of the GUI. In some examples, content of interest module 280 determines content of interest based on gaze tracking data received from eye gaze module 282, content ID module 284, application manager module 268 and/or ML module 288. Content interest module 280 may determine that a first portion of the GUI includes the content of interest, and a second portion of the GUI includes content that is not of interest or of less interest to the user.

Content of interest module 280 may determine whether to split the graphical user interface (706). In order to determine whether to split the GUI, content of interest module 280 may determine a size of the first portion and a size of the second portion, as well as whether the sizes satisfy one or more threshold sizes. In some examples, the second portion of the GUI may be too small to display a graphical keyboard without the graphical keyboard occluding at least some of the content of interest in the first portion. That is, content of interest module 280 may determine that a size of the second portion does not satisfy a threshold size, where the threshold size is correlated with a minimum-sized graphical keyboard.

In response to content of interest module 280 determining that the size of the second portion does not satisfy the threshold size, screen portion module 290 may execute a split screen mode in the GUI (YES branch of 706). Screen portion module 290 may split the GUI into at least a first partition and a second partition (708). Screen portion module 290 may include the content of the first portion of the GUI within the first partition and the content of the second portion of the GUI within the second partition. The first partition may be smaller in size on the GUI than the first portion was before the split. Screen portion module 290 may resize the content within the first portion of the GUI such that it fits within the smaller first partition. The second partition may be larger in size on the GUI than the second portion was before the split. The second partition after the split may be large enough that a majority of the graphical keyboard may visually overlay the second partition.

UI manager module 276 may cause user interface device 254 to output an updated GUI for display on user interface device 254, including the graphical keyboard according to information received from graphical keyboard module 294, such that a majority of the graphical keyboard visually overlays the second partition (710). For example, UI manager module 276 of computing device 200 may update the GUI such that it includes a first GUI in the first partition and at least a second GUI in the second partition. The first GUI may include the content of interest of the GUI before the split, and the second GUI may include the graphical keyboard.

In response to determining that the size of the second portion satisfies the threshold size, the method may not include splitting the GUI (NO branch of 706). That is, content of interest module 280 may determine a second portion of the GUI that does not contain content of interest and that the second portion is large enough to display a graphical keyboard. UI manager module 276 may cause user interface device 254 to output an updated GUI for display on user interface device 254, including the graphical keyboard according to information received from graphical keyboard module 294, such that a majority of the graphical keyboard visually overlays the second portion of the GUI (712).

Various aspects of the techniques described in this disclosure may be directed to the examples listed below.

Example 1: A method comprising: outputting, by one or more processors of a computing device and for display by a display device, a graphical user interface; determining, by the one or more processors, that a first portion of the graphical user interface includes content having at least a threshold probability of being viewed by the user of computing device 200, wherein the graphical user interface further includes a second portion, wherein the first portion and second portion are non-overlapping portions of the graphical user interface, and outputting, by the one or more processors and for display by the display device, an updated graphical user interface including a graphical keyboard such that a majority of the graphical keyboard visually overlays the second portion of the graphical user interface.

Example 2: The method of example 1, wherein the second portion of the graphical user interface does not include content having at least a threshold probability of being viewed by the user of the computing device.

Example 3: The method of example 1 or 2, further comprising: determining, by the one or more processors, whether a size of the second portion of the graphical user interface satisfies a threshold size; and responsive to determining that the size of the second portion does not satisfy the threshold size, splitting, by the one or more processors, the graphical user interface into at least a first partition and a second partition, wherein: the first portion of the graphical user interface is included within the first partition of the graphical user interface; and the graphical keyboard is included within the second partition of the graphical user interface.

Example 4: The method of any of examples 1 to 3, wherein the content included in the first portion of the graphical user interface is a first portion of content from a plurality of portions of content included in the graphical user interface, the method further comprising: determining, by the one or more processors, whether the user has viewed a respective portion of content from the plurality of portions of content within a threshold amount of time; and responsive to determining that the user has not viewed the respective portion within the threshold amount of time, determining, by the one or more processors, that the respective portion of the content of the graphical user interface is part of the second portion of the graphical user interface.

Example 5: The method of any of examples 1 to 4, wherein determining that the first portion of the graphical user interface includes content having at least the threshold probability of being viewed by the user of the computing device comprises: tracking, by the one or more processors, eye movements of the user, determining, by the one or more processors and based on the eye movements, a probability that the user will view or is viewing at least a portion of the content of the graphical user interface; determining, by the one or more processors, whether the probability satisfies the threshold probability; and responsive to determining that the probability satisfies the threshold probability, determining, by the one or more processors, that the portion of the content of the graphical user interface includes content having at least a threshold probability of being viewed by the user of the computing device.

Example 6: The method of any of examples 1 to 5, further comprising: tracking, by the one or more processors, eye movements of the user; determining, by the one or more processors and based on the eye movements of the user, a number of times the user looks at content included in a third portion of the graphical user interface; determining, by the one or more processors, whether the number satisfies a threshold number; and responsive to determining that the number does not satisfy the threshold number, determining, by the one or more processors, that the third portion does not include content satisfying the threshold probability of being viewed by the user of the computing device.

Example 7: The method of any of examples 1 to 6, further comprising: determining, by the one or more processors, whether promotional content is included within the graphical user interface; and responsive to determining that promotional content is included within the graphical user interface, determining, by the one or more processors, that the space on the graphical user interface occupied by the promotional content does not include content satisfying the threshold probability of being viewed by the user of the computing device.

Example 8: The method of any of examples 1 to 7, further comprising: determining, by the one or more processors, whether a video or image is included in the graphical user interface; and responsive to determining that a video or image is included in the graphical user interface, determining, by the one or more processors, that the video or image includes content that satisfies the threshold probability of being viewed by the user of the computing device.

Example 9: The method of any of examples 1 to 8, further comprising: determining, by the one or more processors, whether a third portion of the graphical user interface includes an active text field, wherein the active text field is a text field having a current cursor focus; and responsive to determining that the third portion includes the active text field, determining, by the one or more processors, that the third portion includes content that satisfies the threshold probability of being viewed by the user of the computing device.

Example 10: The method of example 9, further comprising: determining, by the one or more processors, whether a fourth portion of the graphical user interface includes content that satisfies the threshold probability of being viewed by the user of the computing device, wherein the fourth portion is located adjacent to the active text field; and responsive to determining that the fourth portion does not include content that satisfies the threshold probability of being viewed by the user of the computing device, outputting, by the one or more processors and for display by the display device, an updated graphical user interface including a graphical keyboard such that a majority of the graphical keyboard visually overlays the fourth portion of the graphical user interface.

Example 11: The method of any of examples 1 to 10, further comprising: determining, by the one or more processors, a respective amount of time each application from one or more currently executing applications has been visible on the display device of the computing device; identifying, by the one or more processors and based on the respective amounts of time the one or more currently executing applications have been visible on the display device, one application from the one or more currently executing applications that has been visible on the display device for a greatest amount of time; and determining, by the one or more processors, that content associated with the one application includes content that satisfies the threshold probability of being viewed by the user of the computing device.

Example 12: The method of example 1 to 11, further comprising: determining, by the one or more processors, whether a third portion of the graphical user interface includes blank space; and responsive to determining that the third portion of the graphical user interface includes blank space, determining, by the one or more processors, that the third portion does not include content that satisfies the threshold probability of being viewed by the user of the computing device.

Example 13: A computing system includes a display device, one or more processors, and a memory that stores instructions, wherein the instructions, when executed by the one or more processors, cause the one or more processors to output, for display by the display device, a graphical user interface, and determine that a first portion of the graphical user interface includes content having at least a threshold probability of being viewed by a user of the computing device, wherein the graphical user interface further includes a second portion, and wherein the first portion and second portion are non-overlapping portions of the graphical user interface. The instructions may further cause the one or more processors to output, for display by the display device, an updated graphical user interface including a graphical keyboard such that a majority of the graphical keyboard visually overlays the second portion of the graphical user interface.

Example 14: The computing system of example 13, wherein the second portion of the graphical user interface does not include content having at least a threshold probability of being viewed by the user of the computing device.

Example 15: The computing system of example 13 or 14, wherein the instructions further cause the one or more processors to: determine whether a size of the second portion of the graphical user interface satisfies a threshold size; and, responsive to determining that the size of the second portion does not satisfy the threshold size, split the graphical user interface into at least a first partition and a second partition, wherein the first portion of the graphical user interface is included within the first partition of the graphical user interface, and wherein the graphical keyboard is included within the second partition of the graphical user interface.

Example 16: The computing system of any of examples 13 to 15, wherein the content included in the first portion of the graphical user interface is a first portion of content from a plurality of portions of content included in the graphical user interface, and wherein the instructions further cause the one or more processors to: determine whether the user has viewed a respective portion of content from the plurality of portions of content within a threshold amount of time, and, responsive to determining that the user has not viewed the respective portion within the threshold amount of time, determine that the respective portion of the content of the graphical user interface is part of the second portion of the graphical user interface.

Example 17: The computing system of any of examples 13 to 16, wherein the instructions that cause the one or more processors to determine that the first portion of the graphical user interface includes content having at least the threshold probability of being viewed by the user of the computing device further include instructions that cause the one or more processors to: track eye movements of the user; determine, based on the eye movements, a probability that the user will view or is viewing at least a portion of the content of the graphical user interface; determine whether the probability satisfies the threshold probability; and, responsive to determining that the probability satisfies the threshold probability, determine that the portion of the content of the graphical user interface includes content having at least a threshold probability of being viewed by the user of the computing device.

Example 18: The computing system of any of examples 13 to 17, wherein the instructions further cause the one or more processors to: track eye movements of the user; determine, based on the eye movements of the user, a number of times the user looks at content included in a third portion of the graphical user interface; determine whether the number satisfies a threshold number; and responsive to determining that the number does not satisfy the threshold number, determine that the third portion does not include content satisfying the threshold probability of being viewed by the user of the computing device.

Example 19: The computing system of any of examples 13 to 18, wherein the instructions further cause the one or more processors to: determine whether promotional content is included within the graphical user interface; and, responsive to determining that promotional content is included within the graphical user interface, determine that the space on the graphical user interface occupied by the promotional content does not include content satisfying the threshold probability of being viewed by the user of the computing device.

Example 20: The computing system of any of examples 13 to 19, wherein the instructions further cause the one or more processors to: determine whether a video or image is included in the graphical user interface; and, responsive to determining that a video or image is included in the graphical user interface, determine that the video or image includes content that satisfies the threshold probability of being viewed by the user of the computing device.

Example 21: The computing system of any of examples 13 to 20, wherein the instructions further cause the one or more processors to: determine whether a third portion of the graphical user interface includes an active text field, wherein the active text field is a text field having a current cursor focus; and responsive to determining that the third portion includes the active text field, determine that the third portion includes content that satisfies the threshold probability of being viewed by the user of the computing device.

Example 22: The computing system of example 21, wherein the instructions further cause the one or more processors to: determine whether a fourth portion of the graphical user interface includes content that satisfies the threshold probability of being viewed by the user of the computing device, wherein the fourth portion is located adjacent to the active text field; and responsive to determining that the fourth portion does not include content that satisfies the threshold probability of being viewed by the user of the computing device, output, for display by the display device, an updated graphical user interface including a graphical keyboard such that a majority of the graphical keyboard visually overlays the fourth portion of the graphical user interface.

Example 23: The computing system of any of examples 13 to 22, wherein the one or more processors are further configured to: determine a respective amount of time each application from one or more currently executing applications has been executing in the foreground; identify, based on the respective amounts of time the one or more currently executing applications have been executing in the foreground, one application from the one or more currently executing applications that has been executing in the foreground for a greatest amount of time; and determine that content associated with the one application includes content that satisfies the threshold probability of being viewed by the user of the computing device.

Example 24: The computing system of any of examples 13 to 23, wherein the instructions further cause the one or more processors to: determine whether a third portion of the graphical user interface includes blank space; and, responsive to determining that the third portion of the graphical user interface includes blank space, determine that the third portion does not include content that satisfies the threshold probability of being viewed by the user of the computing device.

Example 25: A computer-readable storage medium is encoded with instructions that, when executed, cause one or more processors of a computing device to: output, for display by a display device of the computing device, a graphical user interface, and determine that a first portion of the graphical user interface includes content having at least a threshold probability of being viewed by a user of the computing device, wherein the graphical user interface further includes a second portion, wherein the first portion and second portion are non-overlapping portions of the graphical user interface. The instructions may further cause the one or more processors to output, for display by the display device, an updated graphical user interface including a graphical keyboard such that a majority of the graphical keyboard visually overlays the second portion of the graphical user interface.

Example 26: The computer-readable storage medium of example 25, wherein the second portion of the graphical user interface does not include content having at least a threshold probability of being viewed by the user of the computing device.

Example 27: The computer-readable storage medium of example 25 or 26, wherein the instructions further cause the one or more processors to determine whether a size of the second portion of the graphical user interface satisfies a threshold size; and responsive to determining that the size of the second portion does not satisfy the threshold size, split the graphical user interface into at least a first partition and a second partition, wherein: the first portion of the graphical user interface is included within the first partition of the graphical user interface; and the graphical keyboard is included within the second partition of the graphical user interface.

Example 28: The computer-readable storage medium of any of examples 25 to 27, wherein the content included in the first portion of the graphical user interface is a first portion of content from a plurality of portions of content included in the graphical user interface, and wherein the instructions further cause the one or more processors to: determine whether the user has viewed a respective portion of content from the plurality of portions of content within a threshold amount of time; and, responsive to determining that the user has not viewed the respective portion within the threshold amount of time, determine that the respective portion of the content of the graphical user interface is part of the second portion of the graphical user interface.

Example 29: The computer-readable storage medium of any of examples 25 to 28, wherein the instructions that cause the one or more processors to determine that the first portion of the graphical user interface further include instructions that cause the one or more processors to determine content having at least the threshold probability of being viewed by the user of the computing device, and wherein the instructions further cause the one or more processors to: track eye movements of the user; determine, based on the eye movements, a probability that the user will view or is viewing at least a portion of the content of the graphical user interface; determine whether the probability satisfies the threshold probability; and, responsive to determining that the probability satisfies the threshold probability, determine that the portion of the content of the graphical user interface includes content having at least a threshold probability of being viewed by the user of the computing device.

Example 30: The computer-readable storage medium of any of examples 25 to 29, wherein the instructions further cause the one or more processors to: track eye movements of the user; determine, based on the eye movements of the user, a number of times the user looks at content included in a third portion of the graphical user interface; determine whether the number satisfies a threshold number; and responsive to determining that the number does not satisfy the threshold number, determine that the third portion does not include content satisfying the threshold probability of being viewed by the user of the computing device.

Example 31: The computer-readable storage medium of any of examples 25 to 30, wherein the instructions further cause the one or more processors to: determine whether promotional content is included within the graphical user interface; and responsive to determining that promotional content is included within the graphical user interface, determine that the space on the graphical user interface occupied by the promotional content does not include content satisfying the threshold probability of being viewed by the user of the computing device.

Example 32: The computer-readable storage medium of any of examples 25 to 31, wherein the instructions further cause the one or more processors to: determine whether a video or image is included in the graphical user interface; and responsive to determining that a video or image is included in the graphical user interface, determine that the video or image includes content that satisfies the threshold probability of being viewed by the user of the computing device.

Example 33: The computer-readable storage medium of any of examples 25 to 32, wherein the instructions further cause the one or more processors to: determine whether a third portion of the graphical user interface includes an active text field, wherein the active text field is a text field having a current cursor focus; and, responsive to determining that the third portion includes the active text field, determine that the third portion includes content that satisfies the threshold probability of being viewed by the user of the computing device.

Example 34: The computer-readable storage medium of example 33, wherein the instructions further cause the one or more processors to: determine whether a fourth portion of the graphical user interface includes content that satisfies the threshold probability of being viewed by the user of the computing device, wherein the fourth portion is located adjacent to the active text field; and, responsive to determining that the fourth portion does not include content that satisfies the threshold probability of being viewed by the user of the computing device, output, for display by the display device, an updated graphical user interface including a graphical keyboard such that a majority of the graphical keyboard visually overlays the fourth portion of the graphical user interface.

Example 35: The computer-readable storage medium of any of examples 25 to 34, wherein the instructions further cause the one or more processors to: determine a respective amount of time each application from one or more currently executing applications has been executing in the foreground; identify, based on the respective amounts of time the one or more currently executing applications have been executing in the foreground, one application from the one or more currently executing applications that has been executing in the foreground for a greatest amount of time; and determine that content associated with the one application includes content that satisfies the threshold probability of being viewed by the user of the computing device.

Example 36: The computer-readable storage medium of any of examples 25 to 35, wherein the instructions further cause the one or more processors to: determine whether a third portion of the graphical user interface includes blank space; and, responsive to determining that the third portion of the graphical user interface includes blank space, determine that the third portion does not include content that satisfies the threshold probability of being viewed by the user of the computing device.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another. e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

1. A method comprising:
outputting, by one or more processors of a computing device and for display by a display device, a graphical user interface;
determining, by the one or more processors, that a first portion of the graphical user interface includes content having at least a threshold probability of being viewed by a user of the computing device, wherein the graphical user interface further includes a second portion, wherein the first portion and second portion are non-overlapping portions of the graphical user interface; and
outputting, by the one or more processors and for display by the display device, an updated graphical user interface including a graphical keyboard such that a less than majority of the graphical keyboard visually overlays the first portion of the graphical user interface.

2. The method of claim 1, wherein the second portion of the graphical user interface does not include content having at least the threshold probability of being viewed by the user of the computing device.

3. The method of claim 1, further comprising:
determining, by the one or more processors, whether a size of the second portion of the graphical user interface satisfies a threshold size; and
responsive to determining that the size of the second portion does not satisfy the threshold size, splitting, by the one or more processors, the graphical user interface into at least a first partition and a second partition, wherein:
the first portion of the graphical user interface is included within the first partition of the graphical user interface; and
the graphical keyboard is included within the second partition of the graphical user interface.

4. The method of claim 1, wherein the content included in the first portion of the graphical user interface is a first portion of content from a plurality of portions of content included in the graphical user interface, the method further comprising:
determining, by the one or more processors, whether the user has viewed a respective portion of content from the plurality of portions of content within a threshold amount of time; and
responsive to determining that the user has not viewed the respective portion within the threshold amount of time, determining, by the one or more processors, that the respective portion of the content of the graphical user interface is part of the second portion of the graphical user interface.

5. The method of claim 1, wherein determining that the first portion of the graphical user interface includes content having at least the threshold probability of being viewed by the user of the computing device comprises:
tracking, by the one or more processors, eye movements of the user;
determining, by the one or more processors and based on the eye movements, a probability of being viewed by the user of the computing device for at least a portion of the content of the graphical user interface;
determining, by the one or more processors, whether the probability satisfies the threshold probability; and
responsive to determining that the probability satisfies the threshold probability, determining, by the one or more processors, that the portion of the content of the graphical user interface includes content having at least a threshold probability of being viewed by the user of the computing device.

6. The method of claim 1, further comprising:
tracking, by the one or more processors, eye movements of the user;
determining, by the one or more processors and based on the eye movements of the user, a number of times the user looks at content included in a third portion of the graphical user interface;
determining, by the one or more processors, whether the number satisfies a threshold number; and
responsive to determining that the number does not satisfy the threshold number, determining, by the one or more processors, that the third portion does not include content satisfying the threshold probability of being viewed by the user of the computing device.

7. The method of claim 1, further comprising:
determining, by the one or more processors, whether promotional content is included within the graphical user interface; and
responsive to determining that promotional content is included within the graphical user interface, determining, by the one or more processors, that a space on the graphical user interface occupied by the promotional content does not include content satisfying the threshold probability of being viewed by the user of the computing device.

8. The method of claim 1, further comprising:
determining, by the one or more processors, whether a video or image is included in the graphical user interface; and
responsive to determining that a video or image is included in the graphical user interface, determining, by the one or more processors, that the video or image includes content that satisfies the threshold probability of being viewed by the user of the computing device.

9. The method of claim 1, further comprising:
determining, by the one or more processors, whether a third portion of the graphical user interface includes an active text field, wherein the active text field is a text field having a current cursor focus; and
responsive to determining that the third portion includes the active text field, determining, by the one or more processors, that the third portion includes content that satisfies the threshold probability of being viewed by the user of the computing device.

10. The method of claim 9, further comprising:
determining, by the one or more processors, whether a fourth portion of the graphical user interface includes content that satisfies the threshold probability of being viewed by the user of the computing device, wherein the fourth portion is located adjacent to the active text field; and
responsive to determining that the fourth portion does not include content that satisfies the threshold probability of being viewed by the user of the computing device, outputting, by the one or more processors and for display by the display device, an updated graphical user interface including a graphical keyboard such that a majority of the graphical keyboard visually overlays the fourth portion of the graphical user interface.

11. The method of claim 1, further comprising:
determining, by the one or more processors, a respective amount of time each application from one or more currently executing applications has been visible on the display device of the computing device;
identifying, by the one or more processors and based on the respective amounts of time the one or more currently executing applications have been visible on the display device, one application from the one or more currently executing applications that has been visible on the display device for a greatest amount of time; and
determining, by the one or more processors, that content associated with the one application includes content that satisfies the threshold of being viewed by the user of the computing device.

12. The method of claim 1, further comprising:
determining, by the one or more processors, whether a third portion of the graphical user interface includes blank space; and
responsive to determining that the third portion of the graphical user interface includes blank space, determining, by the one or more processors, that the third portion does not include content that satisfies the threshold probability of being viewed by the user of the computing device.

13-15. (canceled)

16. A computing device comprising:
a display device;
one or more processors; and
a memory that stores instructions, wherein the instructions, when executed by the one or more processors, cause the one or more processors to:
output, for display by the display device, a graphical user interface;
determine that a first portion of the graphical user interface includes content having at least a threshold probability of being viewed by a user of the computing device, wherein the graphical user interface further includes a second portion, and wherein the first portion and second portion are non-overlapping portions of the graphical user interface; and
output, for display by the display device, an updated graphical user interface including a graphical keyboard such that a majority of the graphical keyboard visually overlays the second portion of the graphical user interface.

17. The computing device of claim 16, wherein the second portion of the graphical user interface does not include content having at least a threshold probability of being viewed by the user of the computing device.

18. The computing device of claim 16, wherein the instructions further cause the one or more processors to:
determine whether a size of the second portion of the graphical user interface satisfies a threshold size; and
responsive to determining that the size of the second portion does not satisfy the threshold size, split the graphical user interface into at least a first partition and a second partition, wherein the first portion of the graphical user interface is included within the first partition of the graphical user interface, and wherein the graphical keyboard is included within the second partition of the graphical user interface.

19. The computing device of claim 16, wherein the content included in the first portion of the graphical user interface is a first portion of content from a plurality of portions of content included in the graphical user interface, and wherein the instructions further cause the one or more processors to:
determine whether the user has viewed a respective portion of content from the plurality of portions of content within a threshold amount of time; and
responsive to determining that the user has not viewed the respective portion within the threshold amount of time, determine that the respective portion of the content of the graphical user interface is part of the second portion of the graphical user interface.

20. The computing device of claim 16, wherein the instructions that cause the one or more processors to determine that the first portion of the graphical user interface includes content having at least the threshold probability of being viewed by the user of the computing device further include instructions that cause the one or more processors to:
track eye movements of the user;
determine, based on the eye movements, a probability that the user will view or is viewing at least a portion of the content of the graphical user interface;
determine whether the probability satisfies the threshold probability; and
responsive to determining that the probability satisfies the threshold probability, determine that the portion of the content of the graphical user interface includes content having at least a threshold probability of being viewed by the user of the computing device.

21. A non-transitory computer-readable storage medium is encoded with instructions that, when executed, cause one or more processors of a computing device to:
output, for display by a display device of the computing device, a graphical user interface;
determine that a first portion of the graphical user interface includes content having at least a threshold probability of being viewed by a user of the computing device, wherein the graphical user interface further includes a second portion, wherein the first portion and second portion are non-overlapping portions of the graphical user interface, and wherein the second portion of the graphical user interface does not include content having at least a threshold probability of being viewed by the user of the computing device; and
output, for display by the display device, an updated graphical user interface including a graphical keyboard such that a majority of the graphical keyboard visually overlays the second portion of the graphical user interface.

22. The non-transitory computer-readable storage medium of claim 21 wherein the instructions further cause the one or more processors to:
determine whether a size of the second portion of the graphical user interface satisfies a threshold size; and
responsive to determining that the size of the second portion does not satisfy the threshold size, split the graphical user interface into at least a first partition and a second partition, wherein: the first portion of the graphical user interface is included within the first partition of the graphical user interface; and the graphical keyboard is included within the second partition of the graphical user interface.

23. The non-transitory computer-readable storage medium of claim 21, wherein the content included in the first portion of the graphical user interface is a first portion of content from a plurality of portions of content included in the graphical user interface, and wherein the instructions further cause the one or more processors to:
determine whether the user has viewed a respective portion of content from the plurality of portions of content within a threshold amount of time; and
responsive to determining that the user has not viewed the respective portion within the threshold amount of time, determine that the respective portion of the content of the graphical user interface is part of the second portion of the graphical user interface.
